(19) United States
(12) Patent Application Publication
(10) Pub. No.: US 2025/0104124 A1
(43) Pub. Date: Mar. 27, 2025

(54) APPARATUS, METHOD AND SYSTEM

(71) Applicant: IOT CO.LTD., Tokyo (JP)

(72) Inventors: Shigemitsu TAKAISHI, Minato-ku (JP); Hiroshi OTA, Minato-ku (JP); Kageto IMAHASHI, Minato-ku (JP)

(73) Assignee: IOT CO.LTD., Tokyo (JP)

(21) Appl. No.: 18/964,858

(22) Filed: Dec. 2, 2024

Related U.S. Application Data
(63) Continuation of application No. PCT/JP2023/020039, filed on May 30, 2023.

(30) Foreign Application Priority Data
Jun. 29, 2022 (JP) 2022-104130

(51) Int. Cl. G06Q 30/0601; G06N 3/006

(52) U.S. Cl. CPC G06Q 30/0617; G06N 3/006; G06Q 30/0625; G06Q 30/0641

(57) ABSTRACT

An apparatus with processing circuitry configured to accept first information input from the user regarding the user's birth information, generate keywords related to the user based on the first information accepted in accepting the input and the second information about the given date and time, and search for a service site using the keywords and presenting services at the service site to the user based on the search results.

### CROSS-REFERENCE TO RELATED APPLICATIONS

This application is a continuation of International Application No. PCT/JP2023/020039, filed May 30, 2023, which claims priority to Japanese Patent Application No. 2022-104130, filed Jun. 29, 2022, the entire contents of each are incorporated herein by reference.

### FIELD

The present disclosure relates to an apparatus, method and system.

### BACKGROUND

Based on the results of psychological tests, etc., there is technology that generates artificial life forms, commonly referred to as avatars, in a virtual space created by a computer system, and causes these avatars to perform various actions.

Conventional technologies related to the above mentioned technologies are exist.

One conventional technology relates to a virtual space providing apparatus. The virtual space providing apparatus generates DNA to be set in an avatar corresponding to the user based on information input from the user. The virtual space providing apparatus generates avatars from inherent parts determined according to the DNA and acquired parts selected according to the user's selection instructions, and causes them to be placed in the virtual space.

Another conventional technology relates to an on-demand my clone system that generates a my clone by matching the user himself/herself, capturing the facial image of the matched user himself/herself, and giving the captured facial image a personality and conversational ability by using a database such as blood type personality judgment and AI learning function software. The technology is disclosed.

Both of these technologies use psychological tests and the like to define the personality and behavior of avatars. On the other hand, there is a need on the consumer side to recommend suitable products, etc. to an individual on shopping sites, etc., without providing personal information in a form that can identify the individual.

Therefore, the present disclosure was made to solve the above-described problem, the purpose of which is to provide a technology that makes it possible to receive recommendations for an individual without identifying personal information.

### BRIEF DESCRIPTION OF DRAWINGS

FIG. 1 is a diagram illustrating the overview of a system according to a present disclosure.

FIG. 2 is a block diagram illustrating the hardware configuration of the system according to the first embodiment.

FIG. 3 is a diagram illustrating the functional configuration of a terminal device according to the first embodiment.

FIG. 4 is a diagram illustrating the functional configuration of a server according to the first embodiment.

FIG. 5 is a diagram illustrating the functional configuration of an e-commerce server according to the first embodiment.

FIG. 6 is a diagram illustrating the data structure of a user information database according to the first embodiment.

FIG. 7 is a diagram illustrating the data structure of a keyword information database according to the first embodiment.

FIG. 8 is a diagram illustrating the data structure of the site-specific information database according to the first embodiment.

FIG. 9 is a diagram illustrating the data structure of the site browsing information database according to the first embodiment.

FIG. 10 is a diagram illustrating the data structure of the avatar information database according to for the first embodiment.

FIG. 11 is a diagram illustrating the data structure of the keyword database according to the first embodiment.

FIG. 12 is a diagram illustrating the data structure of the purchasing information database according to the first embodiment.

FIG. 13 is a diagram illustrating the data structure of the site browsing information database according to the first embodiment.

FIG. 14 is a flowchart for describing an example of the processing flow in the system according to the first embodiment.

FIG. 15 is a diagram illustrating an example of a screen displayed on a terminal device according to the first embodiment.

FIG. 16 is a diagram illustrating another example of a screen displayed on a terminal device according to the first embodiment.

FIG. 17 is a diagram illustrating yet another example of a screen displayed on a terminal device according to the first embodiment.

FIG. 18 is a diagram illustrating yet another example of a screen displayed on a terminal device according to the first embodiment.

FIG. 19 is a diagram illustrating yet another example of a screen displayed on a terminal device according to the first embodiment.

FIG. 20 is a diagram illustrating yet another example of a screen displayed on a terminal device according to the first embodiment.

FIG. 21 is a diagram illustrating the functional configuration of a server according to the second embodiment.

FIG. 22 is a flowchart for describing an example of the processing flow in the system according to the second embodiment.

FIG. 23 is a diagram illustrating an example of a screen displayed on a terminal device according to the second embodiment.

FIG. 24 is a diagram illustrating another example of a screen displayed on a terminal device according to the second embodiment.

### DETAILED DESCRIPTION

In general, according to one embodiment, there is provided an apparatus comprises a processing circuitry configured to accept first information input from the user regarding the user's birth information, generate keywords related to the user based on the first information accepted in accepting the input and the second information about the given date and time, and search for a service site using the keywords and presenting services at the service site to the user based on the search results.

Hereinafter, an embodiment of the present disclosure will be described with reference to the drawings. In all figures describing the embodiment, common components are denoted by the same numerals, and repeated description will be omitted. Note that the following embodiment does not unreasonably limit the content of the present disclosure written in the claim. Additionally, not all the components illustrated in the embodiment are necessarily essential components of the present disclosure. Additionally, each figure is a schematic diagram, and is not necessarily strictly illustrated.

Additionally, in the following description, “a processor” is one or more processors. Although at least one processor is typically a microprocessor such as a CPU (Central Processing Unit), other types of processors such as a GPU (Graphics Processing Unit) may be used. At least one processor may be single-core or multi-core.

Additionally, at least one processor may be a processor in a broad sense such as a hardware circuit (for example, an FPGA (Field-Programmable Gate Array) or an ASIC (Application Specific Integrated Circuit)) that performs a part or all of processing.

Additionally, in the following description, although an expression such as “xxx table” may be used to describe information that can provide an output to an input, this information may be data having any structure, and may be a learning model such as a neural network that generates an output to an input. Accordingly, “xxx table” can be called “xxx information.”

Additionally, in the following description, the configuration of each table is an example, and one table may be divided into two or more tables, or all or a part of two or more tables may be one table.

Additionally, in the following description, although processing may be described by using a “program” as a subject, the subject of the processing may be a processor (or a device such as a controller including the processor), since the program is executed by the processor to perform defined processing while appropriately using, for example, a storage and/or an interface unit.

A program may be installed in an apparatus such as a calculator, or may be in, for example, a program distribution server or a (for example, non-transitory) recording medium that can be read by a calculator. Additionally, in the following description, two or more programs may be realized as one program, or one program may be realized as two or more programs.

Additionally, in the following description, although an identification number is used as identification information on various targets, the identification information on types other than an identification number (for example, identifier including an alphabetical character and a code) may be adopted.

Additionally, in the following description, when describing elements of the same type without distinguishing them, reference numerals (or common numerals among reference numerals) are used, and when distinguishing and describing elements of the same type, identification numbers (or reference numerals) of the elements may be used.

Additionally, in the following description, a control line and an information line indicate those considered to be required for description, and do not necessarily indicate all control lines and information lines required for products. All configurations may be connected to each other.

### 0 System Overview

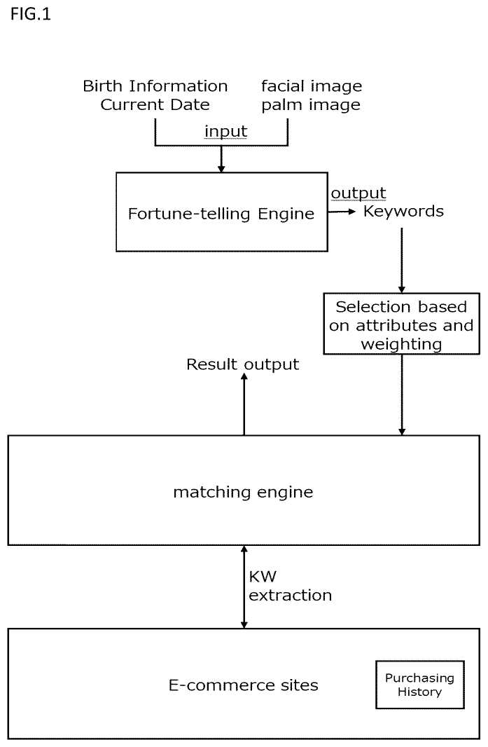

FIG. 1 shows an overview of the operation of the system according to the present disclosure. The system according to the present disclosure accepts input of user-specific information from the user, generates keywords related to the user based on the user-specific information, searches service sites using these keywords, and presents services at service sites to the user based on the search results.

There are two broad categories of information that require input from the user. One is the input of the first information regarding the user's birth information, and the other is the second information regarding the predetermined date and time. The first information regarding the user's birth information is user-specific information. The first information necessarily includes information about the user's date of birth, and may include information about the user's birth time, the location of the user's birth place, and the user's blood type. The system generates keywords based on these first and second information.

The other is at least one of the user's face or palm image. The user's face image or palm image is still user-specific information. The system detects the feature portions of the user's face and their arrangement from the face image and/or the palm lines of the user and their arrangement from the palm image, and generates keywords about the user based on the feature portions of the user's face and their arrangement, and/or the palm lines of the user and their arrangement.

In the system according to the present disclosure, keywords are generated by the divination or fortune-telling engine. In general, fortune-telling is a statistical process in which birth information, facial images, palm images, etc. are used as input data, and the result is derived from the determination of these input data. In this sense, although individual differences among fortune-telling engines are allowed, the keywords output by a single fortune-telling engine are uniquely determined once the input data are determined. As a matter of course, it is possible to have multiple fortune-telling engines in the system pertaining to the present disclosure, and it is also possible for a single fortune-telling engine to output multiple keywords.

In the case of a fortune-telling engine that takes the first information as input, if the second information changes, the keywords output by the fortune-telling engine will also change. For example, if the second information is information about the date and time of the day, the keywords can change according to the day (more precisely, the date and time) on which the fortune-telling engine outputs the keywords.

The form of input of the first information, second information, face image, and palm image is arbitrary. One example is to generate an avatar that acts independently in a virtual space constructed on a terminal device (information processor) such as a smartphone owned by the user, and to ask the user to input the first and other information through conversation with the avatar or text input/output, and to obtain the first and other information from the user. Preferably, at least one of the avatar's behavior pattern and personality is set based on keywords output by the fortune-telling engine. The generated avatar may be used in the system in general for the present disclosure.

The keywords output by the fortune-telling engine may be input to the matching engine described below, but the load on the matching engine may be high because, for example, the fortune-telling engine outputs a large number of keywords. For this reason, the system for the present disclosure may assign attributes and weightings to the keywords output by the fortune-telling engine, and select keywords to be input to the matching engine based on these attributes and/or weightings.

The method of assigning attributes to keywords is arbitrary and not limited to any particular method. One example is a method in which the system pertaining to the present disclosure has a thesaurus dictionary, classifies and categorizes keywords based on this thesaurus dictionary, and assigns attributes associated with these categories to the keywords. Similarly, a method in which the system pertaining to the present disclosure has a morphological analysis engine and assigns attributes to keywords by referring to the part-of-speech classification and word order of the keywords obtained as the output of the morphological analysis engine. Such analysis methods are known and include those implemented in search engines for Internet content.

There is no particular limitation on the meaning of weighting or the method of assigning weighting. One example is a method in which weights are assigned from the perspective of whether or not appropriate services can be presented to users in the matching engine described below.

The keywords output by fortune-telling engines are diverse, and the degree of appropriateness as keywords for service presentation may vary. One example is a method in which this degree of appropriateness is used as a weighting value. Preferably, the weighting value may be assigned based on the attributes assigned to the keywords. As just an example, the weighting value may be increased if the attribute of the keywords is about actions or scenes, and the weighting value may be decreased if the attribute of the keywords is about the user's personality. In other words, if the keywords are about actions or scenes, they will match well with the keywords obtained by the matching engine crawling e-commerce sites (hereinafter referred to as “site keywords”), and are considered to be suitable as keywords for presenting services. On the other hand, in the case of keywords about the user's personality, keywords about the user's personality are highly abstract as keywords, and matching with site keywords is not always good. Naturally, what kind of suitable services can be extracted as a result of matching depends on the performance of the matching engine, and there may be e-commerce sites from which site keywords similar to keywords related to the user's personality can be extracted, so the weighting value of keywords related to the user's personality should not necessarily be low. This does not mean that the weighting value of keywords related to the user's personality should always be low.

On the other hand, in the system for the present disclosure, the matching engine crawls e-commerce sites and extracts site keywords from pages contained in these e-commerce sites. The frequency of crawling of the e-commerce site by the matching engine is arbitrary and can be done at any time, such as crawling periodically, detecting updates to the page content of the e-commerce site and crawling the updated page when it is updated, or crawling when the keyword is output from the fortune-telling engine (or after it is selected as appropriate). The site can be crawled at any timing, such as crawling when a keyword is output from a fortune-telling engine (or after the keyword has been selected as appropriate). The method of crawling pages to extract site keywords is well known in Internet search sites, for example, and is not explained further here.

The matching engine may exist on its own, or it may be realized as a function of an e-commerce site. A function of an e-commerce site refers, as an example, to a form in which keywords are entered into a search window on the top page of an e-commerce site, etc., and pages matching these keywords are presented. In this case, the keywords output by the fortune-telling engine (including those already selected) should be entered into the search window, and the characteristic site keywords should be extracted for the output pages.

If a user has been using an e-commerce site since before, this e-commerce site often has the user's purchase history. The matching engine can refer to this purchase history to make the keywords it retrieves more desirable to the user. In this case, since the purchase history is usually stored in the e-commerce site, it is preferable for the matching engine and/or e-commerce site to obtain the user's account information on the e-commerce site in order to identify which user's purchase history it is. However, in situations such as when a user gives a product as a gift to someone other than the user, or when the e-commerce site does not allow reference to the user's purchase history due to its policies, etc., it is possible to not reference the user's own purchase history.

The matching engine then matches the keywords output by the fortune-telling engine (including those already selected) with the site keywords obtained by crawling the e-commerce site, and presents the services in the e-commerce site to the user based on the site keywords with the highest match rate.

Various for matching keywords and site keywords are known, and there is no particular limitation on the method. One example is a method that simply matches keywords and site keywords and calculates the matching rate (matching score). Another method is to interpret the meanings of keywords and site keywords, cluster each of them, and perform matching based on the distance between clusters. In general, such methods are called data mining. The methods used in data mining are generally suitable for matching keywords to site keywords. Other methods include generating word vectors for keywords and site keywords, respectively, and matching based on the distance between the word vectors as the degree of similarity.

There are various methods of presenting services to users based on the matching rate, and there is no particular limitation on the method. One example is the method of presenting services presented on pages in e-commerce sites that contain site keywords with high matching rates. In this case, the information presented to the user includes the URL (Uniform Resource Locator) of the relevant page on the e-commerce site and the title information of the page (the page title described in the title tag (<title>) in the HTML (HyperText Markup Language) of the page). The page title is described in the title tag (<title>) of the page's HTML (HyperText Markup Language). If a thumbnail image is specified on the page (if there is a description of the image in the HTML header (<head>), this image should be used as the thumbnail image), this thumbnail image should also be presented to the user.

In addition to presenting the user with the very page that contains the site keyword with the high matching rate, or alternatively, the user may be presented with a page that exists at a higher level of hierarchy than the page that contains the site keyword and that straightforwardly indicates the services provided on the page.

The timing of presenting services to user is arbitrary. For example, the crawling of keywords in matching engines and e-commerce sites can be done constantly (repeatedly at regular time intervals), matching can be done constantly, and services can be presented to users at times when users are considered active. Matching can also be done constantly, while services can be presented to the user at times when the user is considered to be active. As an example, services may be presented based on the detection that the user has operated a terminal device such as a smartphone owned by the user, or that it is so-called day time. In addition, the service may be presented by detecting that the user has engaged in the conversation with the avatar described above.

In FIG. 1, an e-commerce site is taken as an example of a service site. However, the system for the present disclosure can be applied to service sites other than e-commerce sites, such as travel sites as an example.

### First Embodiment

### 1 Overall System Configuration Diagram

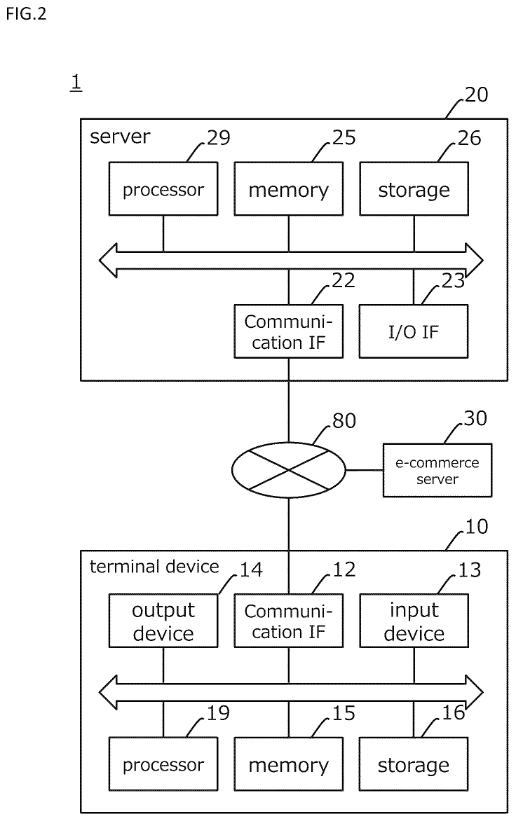

FIG. 2 is a block diagram showing an example of the overall configuration of system 1. The system 1 shown in FIG. 2 includes, for example, a terminal device 10, a server 20, and an e-commerce server 30, which is an example of a service site. The terminal device 10, the server 20, and the e-commerce server 30 communicate and connect via, for example, a network 80.

In FIG. 2, an example is shown where system 1 includes one terminal device 10, but the number of terminal devices 10 included in system 1 is not limited to one. The terminal device 10 is a terminal owned or used by a user who wishes to input his/her own unique information, such as birth information, and receive services based on this unique information.

In this embodiment, a collection of multiple devices may be a single server; the manner in which the multiple functions required to realize the server 20 of this embodiment for one or more pieces of hardware are distributed may be determined as appropriate in light of the processing capabilities of each piece of hardware and/or the specifications required for the server 20 The distribution of the multiple functions required to realize the server 20 of this embodiment to one or more pieces of hardware can be determined from time to time in consideration of the processing capability of each piece of hardware and/or the specifications required for the server 20.

The terminal device 10 shown in FIG. 2 may be, for example, a portable terminal such as a smartphone or tablet, or a stationary PC (Personal Computer) or laptop PC. It may also be a wearable terminal such as a HMD (Head Mount Display), wristwatch-type terminal, etc.

Terminal device 10 is equipped with communication IF (Interface) 12, input device 13, output device 14, memory 15, storage 16, and processor 19.

The communication IF 12 is an interface for the terminal device 10 to input and output signals in order to communicate with devices in the system 1, such as the server 20, for example.

Input device 13 is a device for accepting input operations from the user (e.g., touch panel, touch pad, pointing device such as mouse, keyboard, etc.).

Output device 14 is a device (display, speaker, etc.) for presenting information to the user.

Memory 15 is used to temporarily store programs and data processed by programs, etc., and is a volatile memory such as DRAM (Dynamic Random Access Memory).

Storage 16 is for storing data, e.g., flash memory, HDD (Hard Disc Drive).

The processor 19 is hardware for executing the instruction set described in the program, and consists of arithmetic units, registers, and peripheral circuits.

The e-commerce server 30 is realized, for example, by a computer connected to the network 80. The e-commerce server 30 is a so-called web server, which prepares a number of pages presenting products and services, accepts operation input from users browsing these pages who wish to purchase the products presented on the pages, etc., and performs product delivery, payment settlement, etc. based on this operation input. The e-commerce server 30 may be a server that provides a platform from such product purchase to product delivery, payment settlement, etc. In this case, some of the so-called e-commerce procedures, such as determining the contents described on the page, product delivery, etc., may be performed by individual vendors participating in the e-commerce platform There are cases in which the e-commerce server 30 has a history of past purchases by users of this e-commerce server 30, as described in detail below.

In FIG. 2, the e-commerce server 30 is provided as a stand-alone unit, but a collection of multiple devices may be used as one e-commerce server 30.

Server 20 generates keywords based on the user's unique information provided by terminal device 10 and, if necessary, selects the generated keywords. Server 20 then matches the generated keywords with the site keywords obtained from the e-commerce server 30, and based on the matching results, presents the terminal device 10 (user of the terminal device 10) with the products and services offered on the e-commerce server 30.

In this embodiment, the entity that crawls e-commerce server 30 to obtain site keywords may be server 20, e-commerce server 30, or server 20 and e-commerce server 30 may crawl jointly. Details such as when server 20 crawls e-commerce server 30 are described below.

Server 20 is realized, for example, by a computer (information processing apparatus) connected to network 80. As shown in FIG. 2, server 20 is equipped with communication IF 22, I/O IF 23, memory 25, storage 26, and processor 29.

The communication IF 22 is an interface for the server 20 to input and output signals in order to communicate with devices in the system 1, such as, for example, the terminal device 10.

The input/output IF 23 functions as an input device for accepting input operations from the user and as an interface with output devices for presenting information to the user.

Memory 25 is used to temporarily store programs and data processed by the programs, etc., and is a volatile memory such as DRAM, for example.

Storage 26 is for storing data, e.g., flash memory, HDD.

Processor 29 is the hardware for executing the instruction set described in the program, and consists of arithmetic units, registers, and peripheral circuits.

The hardware configuration of the e-commerce server 30 is identical to that of server 20, so the illustration and description are omitted.

### <1.1 Functional Configuration of Terminal Device>

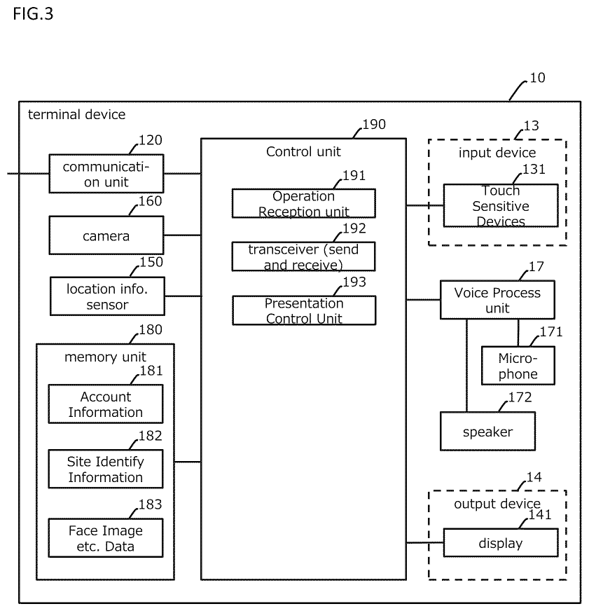

FIG. 3 is a block diagram representing an example of the functional configuration of the terminal device 10 shown in FIG. 2. The terminal device 10 shown in FIG. 3 is realized by, for example, a PC, a portable terminal, or a wearable terminal. As shown in FIG. 3, terminal device 10 is equipped with communication unit 120, input unit 13, output unit 14, audio processing unit 17, microphone 171, speaker 172, camera 160, position information sensor 150, memory unit 180, and control unit 190. Each block in the terminal device 10 is electrically connected by, for example, a bus.

The communication unit 120 performs modulation and demodulation processing and other processing for the terminal device 10 to communicate with other devices. The communication unit 120 applies transmission processing to signals generated by the control unit 190 and transmits them to the outside (e.g., the server 20). The communication unit 120 applies reception processing to signals received from the outside and outputs them to the control unit 190.

Input device 13 is a device for a user operating terminal device 10 to input instructions or information. The input device 13 may be realized by, for example, a keyboard, mouse, reader, etc. When the terminal device 10 is a portable terminal or the like, it may be realized by a touch-sensitive device 131 or the like, in which instructions are input by touching the operation surface. The input device 13 converts instructions input from the user into electrical signals and outputs the electrical signals to the control unit 190. The input device 13 may include, for example, a receiving port that accepts electrical signals input from an external input device.

The output device 14 is a device for presenting information to a user operating the terminal device 10. The output device 14 is realized, for example, by a display 141. The display 141 displays data according to the control of the control unit 190. The display 141 is realized by, for example, an LCD (Liquid Crystal Display) or an OLED (Electro-Luminescence) display.

The audio processing unit 17 performs, for example, digital-to-analog conversion processing of voice signals. The audio processing unit 17 converts the signal given from the microphone 171 into a digital signal and gives the converted signal to the control unit 190. The audio processing unit 17 also gives the voice signal to the speaker 172. The audio processing unit 17 is realized, for example, by a processor for voice processing. The microphone 171 accepts voice input and provides voice signals corresponding to the voice input to the audio processing unit 17. The speaker 172 converts the audio signal provided by the audio processing unit 17 into voice and outputs said voice to the outside of the terminal device 10.

The camera 160 is a device for receiving light with a light receiving element and outputting it as a photographic signal.

The location sensor 150 is a sensor that detects the position of the terminal device 10, for example, a GPS (Global Positioning System) module. a GPS module is a receiving device used in a satellite positioning system. The satellite positioning system receives signals from at least three or four satellites and detects the current position of the terminal device 10 on which the GPS module is mounted based on the received signals. The location sensor 150 may detect the current position of the terminal device 10 based on the location of the wireless base station to which the terminal device 10 is connected.

The memory unit 180 is realized by, for example, memory 15 and storage 16, and stores data and programs used by the terminal device 10. For example, memory unit 180 stores account information 181, site-specific information 182, and face image and other data 183.

The account information 181 is information for identifying the user (account) of the terminal device 10 required to log in to the e-commerce server 30, and is, as an example, a user ID and a user password.

Site-specific information 182 is information that specifies the e-commerce server 30, and is information that the e-commerce server 30 provides to the terminal device 10 when a user of the terminal device 10 logs in using account information 181, etc. The site-specific information 182 is information that the e-commerce server 30 uses to identify the user. An example of such site-specific information 182 is known as an HTTP cookie. However, since cookies are increasingly being avoided by users from the viewpoint of personal information protection, it is preferable to use site-specific information 182 that has little connection to personal information.

The face image and other data 183 is data obtained by the user of terminal device 10 using camera 160 or the like to capture images of the user's own face and palm.

The control unit 190 is realized by the processor 19 reading a program stored in the memory 180 and executing the instructions contained in the program. The control unit 190 controls the operation of the terminal device 10. By operating in accordance with the program, the control unit 190 performs the functions as the operation reception unit 191, the transmission/reception unit 192, and the presentation control unit 193.

The operation reception unit 191 performs processing to accept instructions or information input from the input device 13. Specifically, for example, the operation reception unit 191 accepts information based on instructions input from a keyboard, mouse, or other device.

The operation reception unit 191 also receives voice instructions input from the microphone 171. Specifically, for example, the operation reception unit 191 receives voice signals input from the microphone 171 and converted into digital signals by the audio processing unit 17. The operation reception unit 191 obtains instructions from the user, for example, by analyzing the received voice signal and extracting predetermined nouns.

The transmission/reception unit 192 processes the terminal device 10 to transmit and receive data with an external device, such as the server 20, according to a communication protocol. Specifically, for example, the transmission/reception unit 192 transmits the instruction entered by user the to the server 20. The transmission/reception unit 192 also receives information about the user from the server 20.

The presentation control unit 193 controls the output device 14 to present information provided by the server 20 to the user. Specifically, for example, the presentation control unit 193 causes the information transmitted from the server 20 to be displayed on the display 141. The presentation control unit 193 also causes the information transmitted from the server 20 to be output from the speaker 172.

### <1.2 Functional Configuration of Server 20

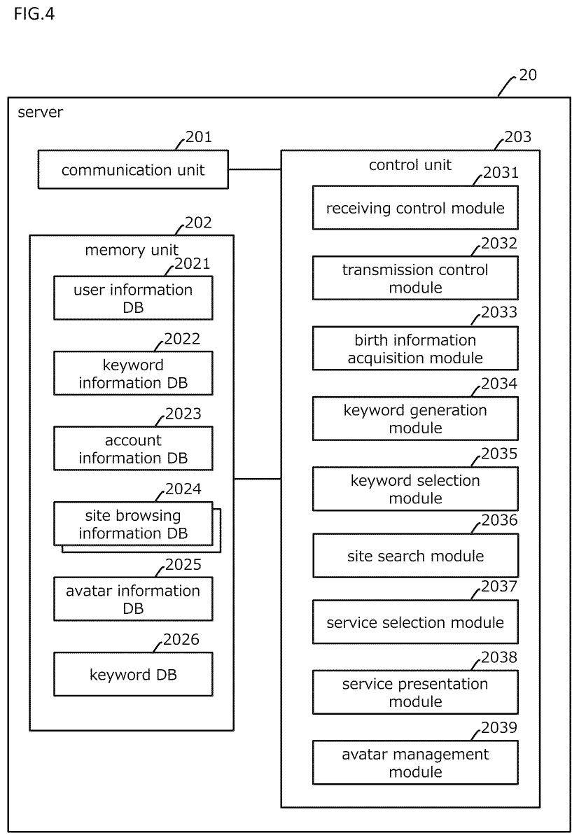

FIG. 4 shows an example of the functional configuration of server 20. As shown in FIG. 4, server 20 functions as communication unit 201, memory unit 202, and control unit 203.

The communication unit 201 processes the server 20 to communicate with external devices.

The memory unit 202 has, for example, user information DB 2021, keyword information DB 2022, account information DB 2023, site browsing information DB 2024, avatar information DB 2025, keyword DB 2026, etc.

The user information DB 2021 is a database for holding information about users (these users are also users of the terminal device 10) who use the system 1 (especially the server 20) in the present embodiment. Details are described below.

Keyword Information DB 2022 is a database for holding information about keywords generated by server 20 (especially keyword generation module 2034, described below). Details are described below.

The account information DB 2023 is a database for holding account information 181 used by users of the terminal device 10 to access the e-commerce server 30. Details are described below.

The site browsing information DB 2024 is a database for holding historical information on the browsing of the e-commerce server 30 by the user of the terminal device 10. This history information includes purchase history information of the e-commerce server 30. Details are described below.

The avatar information DB 2025 is a database for holding information about avatars that perform various actions in the virtual space provided by server 20. Details are described below.

Keyword DB 2026 is a database that the keyword generation module 2034 of server 20 refers to when generating keywords. Details are described below.

The control unit 203 is realized when the processor 29 reads a program stored in the storage unit 202 and executes the instructions contained in the program. By operating according to the program, control unit 203 performs the functions indicated as receiving control module 2031, transmission control module 2032, birth information acquisition module 2033, keyword generation module 2034, keyword selection module 2035, site search module 2036, service selection module 2037, service presentation module 2038, and avatar management module 2039.

The receive control module 2031 controls the process by which the server 20 receives signals from external devices according to a communication protocol.

The transmission control module 2032 controls the process by which the server 20 transmits signals to external devices according to a communication protocol.

The birth information acquisition module 2033 accepts input from the user of the terminal device 10, such as birth information (first information), face image, and palm image, which are unique information of the user. The birth information is stored in the user information DB 2021, and the face and palm images are temporarily stored in the memory unit 202.

Here, birth information necessarily includes information about the user's date of birth and can include information about the user's birth time, the location of the user's birth place, and the user's blood type. The reason for including the user's birth time in the birth information is that the keyword generation module 2034, which is a fortune-telling engine as described below, can output user-specific (in that sense, suitable for the user) keywords by including the birth time as birth information, and the service selection module 2037 and this is because the services presented by the service selection module 2037 and the service presentation module 2038 described below will be more suitable for the user. Similarly, location information of the birthplace of the user is also included as birth information to make the service more suitable for the user. Information on blood type, which categorizes the user into four categories, is likewise included as birth information in order to make the service more suitable for the user.

The birth information acquisition module 2033 may accept birth information input via an avatar generated by the avatar management module 2039, which is described below. As an example, the avatar generated by the avatar management module 2039 may hold a conversation asking the user to input birth information, etc., and the user may respond (input) birth information, etc., to the avatar to accept the input of birth information, etc.

The keyword generation module 2034 generates keywords related to the user based on the birth information, etc. accepted for input by the acquisition module 2033, and stores the generated keywords in the keyword information DB 2022.

The keyword generation module 2034 is the fortune-telling engine described above, and is an engine that performs statistical processing in which results are derived by taking birth information and other data as input, based on the procedures (which can also be called algorithms) possessed by fortune-telling. In this sense, although individual differences are allowed for each fortune-telling engine, for a single fortune-telling engine, once the input data is determined, the keywords output by the fortune-telling engine are uniquely determined. Naturally, it is also possible for the keyword generation module 2034 to have multiple fortune-telling engines and generate a large number of keywords using these multiple engines. It is also possible to allow the user to input the selection of a fortune-telling engine and generate keywords using the selected fortune-telling engine.

Alternatively, the keyword generation module 2034 refers to the keyword DB 2026 and outputs keywords that are uniquely defined using birth information and other information as input. Keyword DB 2026 itself can be generated by storing multiple pre-generated keywords using birth information, etc. as input based on the algorithm described above. In this case, as will be mentioned in the description of the Keyword DB 2026, it is preferable to have multiple keywords associated with a single birth information or other input in the keyword DB 2026. This allows the keyword generation module 2034 to output multiple associated keywords using the birth information, etc. as input.

The fortune-telling engine comprising the keyword generation module 2034 is capable of generating multiple keywords. The multiple keywords generated by the keyword generation module 2034 are selected by the keyword selection module 2035 and matched with the e-commerce server 30.

Here, when the birth information acquisition module 2033 accepts birth information (first information), the keyword generation module 2034 acquires information about a predetermined date and time (second information) in addition to the first information, and generates keywords based on these first and second information. One example of a predetermined date and time is the current date and time when the keyword is generated by the keyword generation module 2034. Another example is information about the date and time when the user actually uses the presented service (e.g., purchases a product, receives a service, etc.). By having the keyword generation module 2034 generate keywords taking into account the second information, for example, even when the same user receives a service (in which case the first information is the same), the service presented to the user can differ depending on the date and time the user uses the system 1 of this disclosure, This results in creating an incentive for the user to repeatedly use the system 1 of this disclosure.

On the other hand, when the birth information, etc. acquisition module 2033 accepts the input of face and palm images, a certain pre-processing is required for the fortune-telling engine to output the keywords. Details are explained in the second embodiment described below.

The keyword selection module 2035 performs the specified selection process for the modules generated by the keyword generation module 2034.

There is no particular limitation on the details of the selection work by the keyword selection module 2035, but from the perspective of not making the service selection work by the service selection module 2037 a huge task, all keywords generated by the keyword generation module 2034 are selected (that is, the number of keywords used by the service selection module 2037, or provide keywords to the service selection module 2037 based on priority).

As an example, the keyword selection module 2035 assigns attributes to keywords generated by the keyword generation module 2034 and stores the assigned attributes in the keyword information DB 2022 associated with the keywords. The method of assigning attribute information by the keyword selection module 2035 has already been described. To repeat, a thesaurus dictionary is stored in the memory unit 202, keywords are classified and categorized based on this thesaurus dictionary, and attributes associated with these categories are assigned to keywords. Another method is to store a morphological analysis engine in memory unit 202, and assign attributes to keywords by referring to the part-of-speech classification and word order of the keywords obtained as the output of the morphological analysis engine.

Alternatively, the keyword selection module 2035 assigns weighting values to the keywords generated by the keyword generation module 2034 and stores the assigned weighting values in the keyword information DB 2022 associated with the keywords. The method of assigning weighting values by the keyword selection module 2035 has already been described, but to repeat, the weighting values may be assigned based on attributes assigned to the keywords by the keyword selection module 2035.

The keyword selection module 2035 then selects keywords for the site search module 2036 to search based on the attributes and weighting values which have assigned to the keywords. The selection process is preferably based on the attributes and weighting values described above. The selection process can be narrowed down to a certain number of keywords, or to keywords that meet certain selection criteria, etc. When selection is based on attributes, etc., the selection work may be based on multiple attributes. Furthermore, when performing selection based on multiple attributes, it may be a method that simply selects keywords with multiple attributes, or a method that creates a hierarchical structure with multiple attributes and successively narrows down the keywords. In addition, the relevance between attributes (relevance such as other attributes recalled from a specific attribute) may be stored in the memory unit 202 in advance, one attribute may be determined, attributes (even multiple attributes) recalled from this attribute may be extracted, and the selection work may be performed based on the extracted attributes.

When selecting keywords based on weighted values, various selection tasks are possible, such as selecting a certain number of keywords in order of increasing weighted value, selecting keywords with weighted values greater than a predetermined value, and so on.

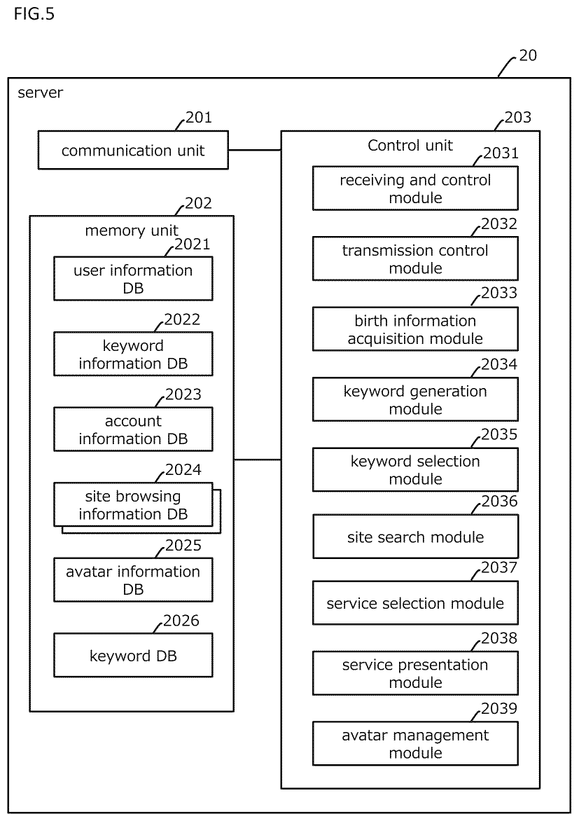

The site search module 2036 searches within the e-commerce server 30 to obtain keywords and temporarily stores the search results, site keywords, in the memory unit 202. In the system 1 of the present embodiment, both the pattern in which server 20 searches e-commerce server 30 and the pattern in which e-commerce server 30 itself searches are described. Which pattern only or both patterns are used together can be defined by System 1. The site search module 2036 is a module used by server 20 to search the e-commerce server 30. If the account information 181 of the user of the e-commerce server 30 is stored in the account information DB 2023, the site search module 2036 uses this account information 181 to refer to the purchase history information DB 3021 and site browsing information DB 302 for each user stored in the e-commerce server 30 (see FIG. 5), and obtain the site keywords from the page where the user has a history of purchasing services on the e-commerce server 30 in the past, or by giving priority to this page. In cases where the e-commerce server 30 does not allow reference to the purchase history information DB 3021 and site browsing information DB 3023 for each user, the site search module 2036 searches within the e-commerce server 30 to obtain keywords without reference to the user's purchase history, and stores the search results, site The keywords may be temporarily stored in memory 202.

The timing of the search of the 30 e-commerce servers by the site search module 2036 is also arbitrary and may be synchronized with the timing of the keyword selection by the keyword selection module 2035, or it may be asynchronous.

The service selection module 2037 is a matching engine and matches the keywords selected by the keyword selection module 2035 with the site search module 2036 or the site search module 3033 of the e-commerce server 30 resulting from a search of the e-commerce server 30. Keyword matching is performed and services in the e-commerce server 30 are selected based on the matched (site) keywords. This type of matching is also a form of “searching e-commerce servers 30 using keywords” in the present embodiment.

The keyword matching process by the service selection module 2037 has already been described. To repeat the outline, the matching process is based on the degree of similarity of the keywords themselves, or the similarity of keywords is determined by text mining.

There is no particular limitation on the method used by the service selection module 2037 to select services based on the keywords obtained as a result of matching. One example is the method of selecting services listed on the page of the e-commerce server 30 that contains the matched keywords, or the method of selecting services that match the category to which the page of the e-commerce server 30 that contains the keywords corresponds.

If the account information 181 of the user of the e-commerce server 30 is stored in the account information DB 2023, the service selection module 2037 may use this account information 181 to refer to the purchase history information DB 3021 and site browsing information DB 3023 for each user stored in the e-commerce server 30, and services in the e-commerce server 30 may be selected based on this purchase history. As an example, if multiple services can be selected as a result of matching keywords with site keywords, if any of these services match the user's purchase history, this service may be selected with priority or selection.

In addition, the service selection module 2037 may refer to the purchase history of other users who share the user's unique information, preferably birth information, which is the first information, and if there is a service that matches the purchase history of other users, this service may also be additionally or independently prioritized or selected for selection.

The timing of the service selection work by the service selection module 2037 is also arbitrary and may be performed immediately after the search of the e-commerce server 30 by the site search module 2036 is completed, upon trigger from the terminal device 10, or periodically.

The service presentation module 2038 presents the services in the e-commerce server 30 selected by the service selection module 2037 to the terminal device 10 owned by the user who entered the unique information from which the keywords were created. Various forms of presenting services by the service presentation module 2038 can be adopted, as already described.

The service presentation module 2038 also refers to the site browsing information DB 2024 of the e-commerce server 30 and attaches parameter values to keywords based on the user's browsing history in the e-commerce server 30 stored in this site browsing information DB 2024. Although the method of attaching parameter values is arbitrary, as an example, the parameter value is increased if the user purchases a service, etc., as a result of the presentation of information about the service to the user by the service presentation module 2038, and the parameter value is decreased if the user does not purchase the service, etc. The service presentation module 2038 stores the given parameter value in the keyword information DB 2022, and if the parameter value is changed, it stores the changed parameter value in the keyword information DB 2022 as well.

Similarly, the service presentation module 2038 refers to the site browsing information DB 2024 of the e-commerce server 30 and, based on the user's browsing history in the e-commerce server 30 stored in this site browsing information DB 2024, detects the time spent on the e-commerce server 30. The service presentation module 2038 then increases or decreases the value of the parameter based on this time spent.

The avatar management module 2039 creates a virtual space in server 20, generates an avatar for each user in this virtual space, and causes the avatar to act in the virtual space. The avatar management module 2039 determines the behavior pattern and personality of the avatar for each user by referring to the avatar information DB 2025, and causes the avatar to perform various actions in the virtual space based on the determined behavior pattern and personality. The behavior pattern and personality of each user's avatar stored in the avatar information DB 2025 may be set by the avatar management module 2039 by assigning predefined values in advance, or they may be determined by the avatar management module 2039 based on keywords generated by the keyword generation module 2034. The avatar may also be determined by the avatar management module 2039 based on keywords generated by the keyword generation module 2034. The avatar's behavior pattern and personality may also be set and changed by the avatar management module 2039 based on conversational input (mainly from the user) between the user and the avatar.

<1.3 Functional Configuration of the e-Commerce Server 30>

FIG. 5 shows an example of the functional configuration of the e-commerce server 30. As shown in FIG. 5, the e-commerce server 30 functions as a communication unit 301, a memory unit 302, and a control unit 303.

The communication unit 301 processes the e-commerce server 30 to communicate with external devices.

The memory unit 302 has, for example, purchase history information DB 3021, screen page data 3022, site browsing information DB 3023, etc.

The purchase history information DB 3021 is a database for holding information on the history of purchases of services, products, etc. on the e-commerce server 30 by users of the e-commerce server 30. Details are described below.

Screen page data 3022 is data used to configure pages on the e-commerce server 30.

The site browsing information DB 3023 is a database for holding historical information on the browsing of the e-commerce server 30 by the user of the terminal device 10. This history information includes purchase history information of the e-commerce server 30. Details are described below.

The control unit 303 is realized by the processor of the e-commerce server 30 reading the program stored in the storage unit 302 and executing the instructions contained in the program. By operating according to the program, the control unit 303 performs the functions shown as follows: receiving control module 3031, sending control module 3032, in-site search module 3033, information presentation module 3034, site browsing detection module 3035, e-commerce module 3036, and payment module 3037 The functions shown as follows.

The receiving control module 3031 controls the process by which the e-commerce server 30 receives signals from external devices according to a communication protocol.

The transmission control module 3032 controls the process by which the e-commerce server 30 transmits signals to external devices according to a communication protocol.

The within-site search module 3033 searches within the e-commerce server 30 to obtain keywords, and temporarily stores the search results, site keywords, in the memory unit 302. The within-site search module 3033 is a module used by the e-commerce server 30 to search its own e-commerce server 30. The within-site search module 3033 may refer to the user's purchase history information DB 3021 and site browsing information DB 3023 to obtain site keywords from pages where there is a history of past user purchases of services on the e-commerce server 30, or this page may be given priority.

The timing of the search of the e-commerce server 30 by the site search module 3033 is also arbitrary and may be synchronized with the timing of the keyword selection by the keyword selection module 2035, or it may be searched asynchronously.

The information presentation module 3034 selects a service in the e-commerce server 30 based on the matching results and sends information about this service to the service presentation module 2038 upon request from the server 20, especially the service selection module 2037.

The site browsing detection module 3035 detects that visitors in the e-commerce server 30, including the user, have browsed the e-commerce server 30 and stores this browsing history in the site browsing information DB 2024.

The e-commerce module 3036 generates pages for e-commerce transactions using screen page data 3022 and the like for visitors, including users who browse (visit) the e-commerce server 30, and transmits the pages to the visitors' terminals (including users' terminal devices 10), transits the pages based on operation inputs from the visitors, and if a purchase input is received, services and products related to the input are sold and provided to the visitor. The operation of the e-commerce module 3036 is well known and will not be described further.

The settlement module 3037 handles the settlement process, including external settlement servers, once there has been a sale of services or other items by the e-commerce module 3036.

### 2 Data Structure

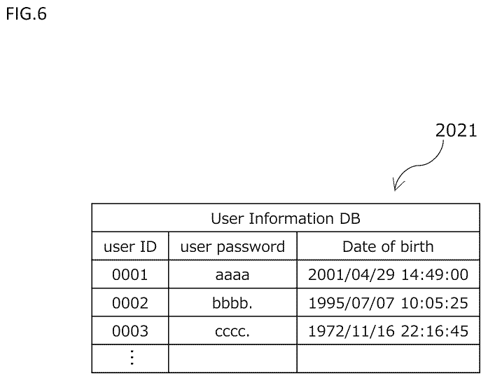

FIGS. 6 through 13 show the data structure of the databases stored by server 20 and e-commerce server 30. FIGS. 6 through 13 are examples and do not exclude data not listed.

The databases shown in FIGS. 6 through 13 refer to relational databases, which are used to manage data sets called tables in tabular form, structurally defined by rows and columns, in relation to each other. In a database, a table is called a table, a table column is called a column, and a table row is called a record. In a relational database, relationships between tables can be set up and related to each other.

Normally, each table is set with a column that serves as a primary key to uniquely identify a record, but setting a primary key to a column is not mandatory. The control units 203 and 303 of the server 20 and e-commerce server 30 can cause the processor 29 to add, delete, and update records in specific tables stored in the storage units 202 and 302 according to various programs.

FIG. 6 shows the data structure of the user Information DB 2021. As shown in FIG. 6, each of the records in the user information DB 2021 includes, for example, the item “user ID,” the item “user PW,” and the item “birth date and time”. Of the information stored in the user information DB 2021, the items “user ID” and “user PW” are information given by the control unit 203 when the user registers for the first time with the system 1 of this embodiment, and the item “birth date and time” is information obtained from the user by the birth information acquisition module 2033 of the server 20. The information stored in the user information DB 2021 can be changed or updated as necessary.

The item “User ID” is an ID to identify the user who uses the system 1 (especially server 20) of this embodiment. The item “user PW” is the password used by the user to log in to the system 1 of the present embodiment. Server 20 authenticates the user using these items “User ID” and “User PW” and the information entered by the user at login. The item “birth date and time” is the birth information of the user, which is the first information obtained by the birth information acquisition module 2033.

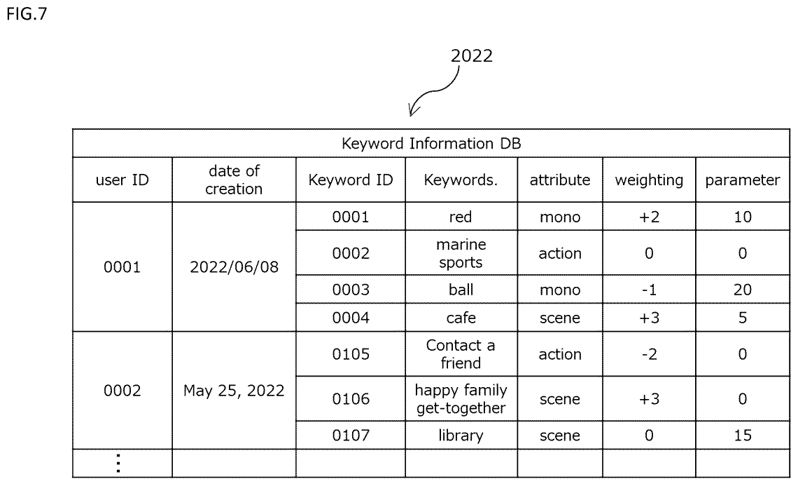

FIG. 7 shows the data structure of the keyword information DB 2022. As shown in FIG. 7, each of the records in the keyword information DB 2022 includes, for example, the item “user ID,” the item “generation date,” the item “keyword ID,” the item “keyword,” the item “attribute,” the item “weighting,” and the item “parameter”. Of the information stored in the keyword information DB 2022, the items “user ID,” “generation date,” “keyword ID,” and “keywords” are information generated by the keyword generation module 2034 with reference to the user information DB 2021, and the items “attributes” and “weighting” are generated by the keyword selection module 2035. The item “parameter” is generated by the service selection module 2037. The information stored by the keyword information DB 2022 can be changed or updated as necessary.

The item “user ID” is an ID to identify the user, and is common to the item “user ID” in the user information DB 2021. The item “generation date” is information indicating the date when the keyword was generated by the keyword generation module 2034. The item “keyword ID” is information to identify the keyword generated by the keyword generation module 2034. The item “keyword” is information that indicates the keyword identified by the keyword ID. In this form of keyword information DB 2022, keywords are classified by user and by date of generation. Therefore, even if the “keywords” are the same information, they are managed as different keywords if the user and creation date are different. The item “attribute” is information indicating the attribute of the keyword identified by the keyword ID. The item “weighting” is information indicating the weighting value of the keyword identified by the keyword ID. In the example shown in FIG. 7, the weighting value takes positive and negative values centered on 0, but the weighting value is not limited to the illustrated example. The item “parameter” is information indicating the parameter value of the keyword identified by the keyword ID. In the example shown in FIG. 7, the parameter value is 0 or higher, but the parameter value is not limited to the illustrated example.

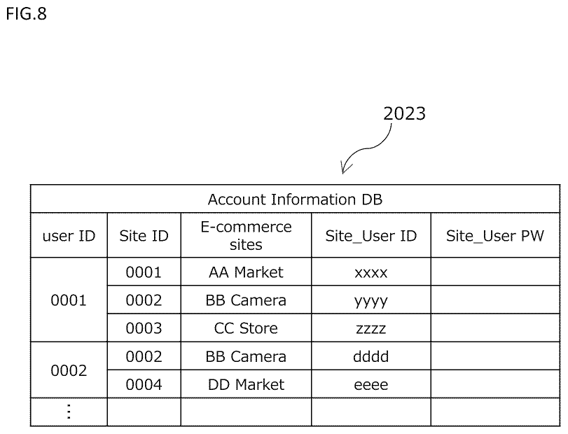

FIG. 8 shows the data structure of the account information DB 2023. As shown in FIG. 8, each of the records in the account information DB 2023 includes, for example, an item “user ID,” an item “site ID,” an item “e-commerce site,” an item “site_user ID,” and an item “site_user PW”. Of the information stored in the account information DB 2023, the items “user ID” and “site ID” are information given by the control unit 203, and the items “e-commerce site,” “site_user ID,” and “site_user PW” are information obtained by the user by providing account information 181 in the terminal device 10 to the control unit 203. The items “e-commerce site,” “site_user ID,” and “site_user PW” are information obtained by the user by providing the account information 181 in the terminal device 10 to the control unit 203. The information stored by the account information DB 2023 can be changed or updated as necessary.

The item “user ID” is an ID to identify the user, and is common to the item “user ID” in the user information DB 2021. The item “site ID” is information for identifying the e-commerce server (site) 30 that requires the account information 181. The item “e-commerce site” is information about the name of the e-commerce server (site) 30 identified by the item “site ID”. The item “site_user ID” is information about the user ID required to log in to the e-commerce server (site) 30 identified by the item “site ID” under the user's name. The item “site_user PW” is information related to the user password required when logging into the e-commerce server (site) 30 identified by the item “site ID” in the user's name.

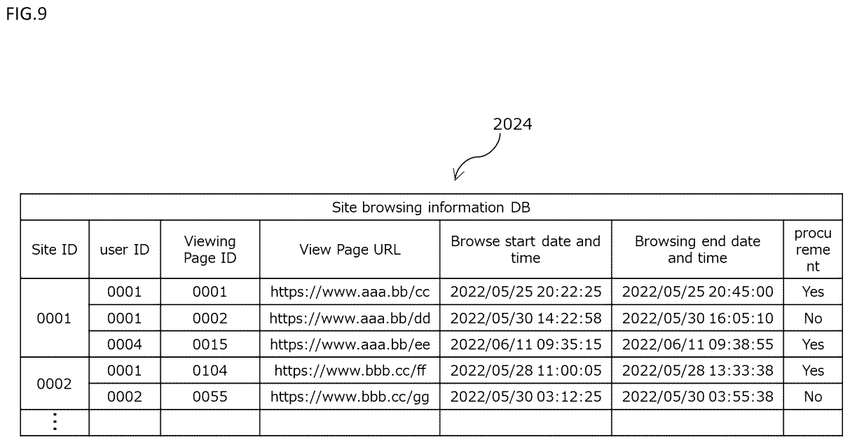

FIG. 9 shows the data structure of the site browsing information DB 2024. As shown in FIG. 9, each of the records in the site browsing information DB 2024 includes, for example, the item “site ID,” the item “user ID,” the item “browsing page ID,” the item “browsing page URL,” the item “browsing start date/time,” the item “browsing end date/time,” and the item “purchase”. The information stored in the site browsing information DB 2024 is an aggregate of the site browsing information DB 3023 of the e-commerce server 30, and the control unit 203 adds information for identifying the e-commerce server (site) 30 to the site browsing information DB 3023 provided by the e-commerce server 30. The site browsing information DB 2024 is the information provided by the e-commerce server (site) 30. The information stored by the site browsing information DB 2024 can be changed or updated as needed.

The item “site ID” is information for identifying the e-commerce server (site) 30 and is common to the “site ID” in the account information DB 2023. The item “user ID” is an ID to identify a user, and is common to the item “user ID” in the user information DB 2021. The item “browsing page ID” is information for identifying the page viewed by the user identified by the user ID in the e-commerce server (site) 30. The item “browsing page URL” is information about the URL of the page on the e-commerce server (site) 30 identified by the item “browsing page ID. The item “browsing start date/time” is information about the date/time when the user identified by the user ID started browsing the page on the e-commerce server (site) 30 identified by the item “browsing page ID”. The item “browsing end date/time” is information on the date and time when the user identified by the user ID finished browsing the page on the e-commerce server (site) 30 identified by the item “browsing page ID”. The item “purchase” is information on whether or not the user identified by the user ID purchased the service, etc. as a result of viewing the page of the e-commerce server (site) 30 identified by the item “browsing page ID”.

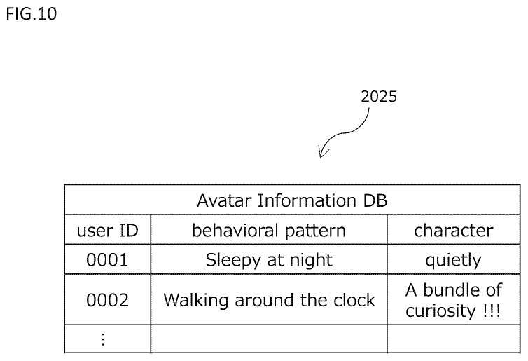

FIG. 10 shows the data structure of the avatar information DB 2025. As shown in FIG. 10, each of the records in the avatar information DB 2025 includes, for example, the item “user ID,” the item “behavior pattern,” and the item “personality.” The information stored in the avatar information DB 2025 is information generated by the avatar management module 2039 and stored in the avatar information DB 2025. The information stored by the avatar information DB 2025 can be changed or updated as needed.

The item “user ID” is an ID to identify the user, and is common to the item “user ID” in the user information DB 2021. The item “behavior pattern” is the avatar representing the user identified by the item “user ID” and is information for specifying the behavior pattern of the avatar generated by the avatar management module 2039. The item “personality” is the avatar representing the user identified by the item “user ID” and is information for specifying the personality of the avatar generated by the avatar management module 2039. The avatar management module 2039 specifies various behaviors of the avatar in the virtual space based on the information stored in the avatar information DB 2025, and causes the avatar to perform the specified behaviors.

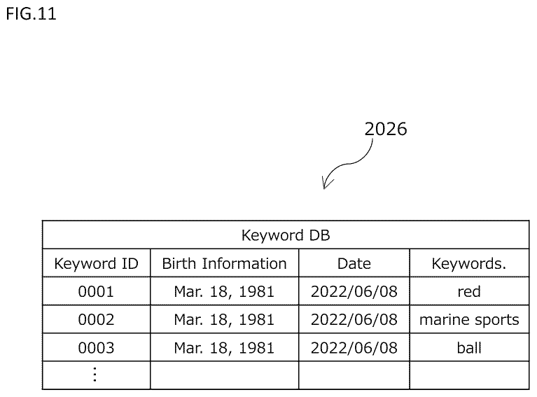

FIG. 11 shows the data structure of the keyword DB 2026. As shown in FIG. 11, each of the records in the keyword DB 2026 includes, for example, the item “keyword ID,” the item “birth information,” the item “date and time,” and the item “keyword.” The information stored in the keyword information DB 2022 is information generated by the keyword generation module 2034. The information stored by the keyword DB 2026 can be changed or updated as needed.

The item “keyword ID” is information for identifying keywords generated by the keyword generation module 2034. The item “birth information” is birth information uniquely associated with the keyword identified by the keyword ID. The item “date” is the date uniquely associated with the keyword identified by the keyword ID. The item “keyword” is information indicating the keyword identified by the keyword ID.

As shown in FIG. 11, in the keyword DB 2026, multiple keywords are associated with a single birth information or other input. This allows the keyword generation module 2034 to output multiple associated keywords using birth information, etc. as input.

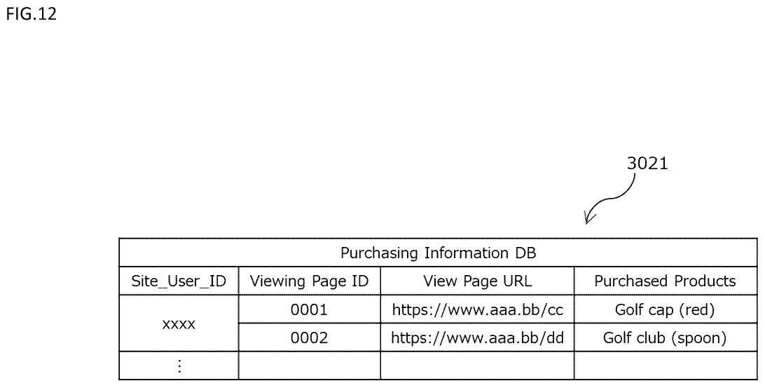

FIG. 12 shows the data structure of the purchase history information DB 3021. As shown in FIG. 12, each of the records in the purchase history information DB 3021 includes, for example, an item “site_user ID,” an item “browsing page ID,” an item “browsing page URL,” and an item “purchased product.” The information stored in the purchase history information DB 3021 is created by the site browsing detection module 3035 and the e-commerce module 3036 and stored in the purchase history information DB 3021. The information stored by the purchase history information DB 3021 can be changed or updated as needed.

The item “site_user ID” is information for identifying the user on the e-commerce server 30, and is common to the item “site_user ID” in the account information DB 2023. The item “viewed page ID” is information for identifying the page viewed by the user identified by the item “site_user ID” and is common to the item “viewed page ID” in the account information DB 2023. The item “browsing page URL” is information about the URL of the e-commerce server (site) 30 identified by the item “browsing page ID”, and is common to the item “browsing page URL” in the account information DB 2023. The item “purchased product” is information about the name of the purchased service, etc., when the user identified by the item “site_user ID” purchased the service, etc. on the page of the e-commerce server (site) 30 identified by the item “browsing page ID”.

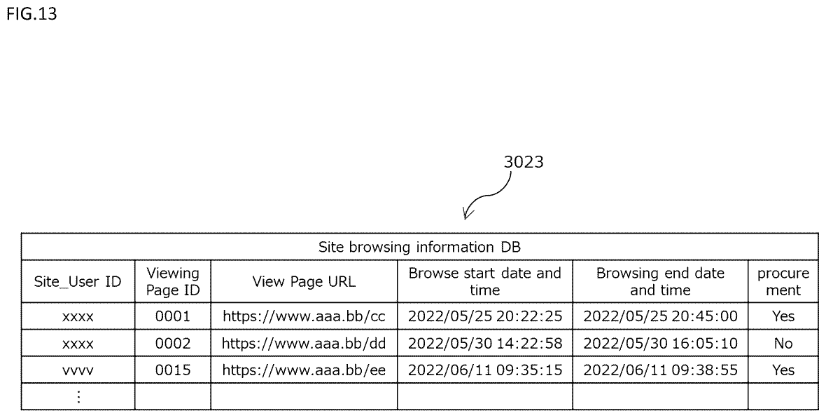

FIG. 13 shows the data structure of the site browsing information DB 3023. As shown in FIG. 13, each of the records in Site Browsing Information DB 3023 is a record of site browsing information DB 2024 shown in FIG. 9, excluding the items “Site ID” and “User ID” and adding the item “site_user ID” instead. In other words, the site browsing information DB 3023 is a history that indicates which pages in the e-commerce server (site) 30 the user identified by the item “site_user ID” has browsed and whether or not he/she has purchased services, etc. on the browsed pages on the stand-alone e-commerce server (site) 30. The records have already been explained. Since each of the records has already been explained, the explanation here is omitted.

### 3 Example of Operation

The following is an example of the operation of server 20.

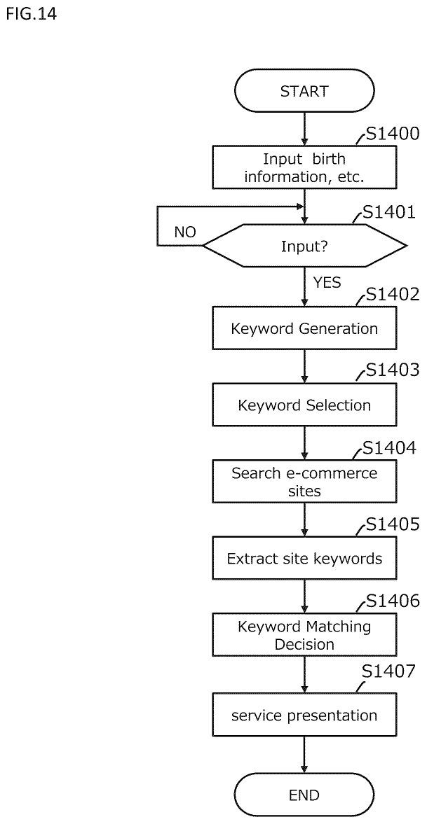

FIG. 14 is a flowchart representing an example of the operation of server 20. FIG. 14 shows an example of the operation of server 20 in which the user of terminal device 10 inputs first information, which is birth information, server 20 generates and selects keywords based on this first information, etc., server 20 matches the selected keywords with site keywords obtained from e-commerce server 30, and based on this matching result server 20 This flowchart shows an example of the operation when presenting a service to a user of terminal device 10.

In step S1400, control unit 203 sends screen data to terminal device 10 requesting input of birth information, etc. of the user of terminal device 10. Specifically, for example, the control unit 203 generates screen data using the birth information, etc., acquisition module 2033 and sends the generated screen data to the terminal device 10 via the network 80. The control unit 190 of the terminal device 10 to which the screen data is sent receives the screen data via, for example, the transmission/reception unit 192 and the communication unit 120, and generates and displays a predetermined display screen on the display 141 based on the received screen data by the presentation control unit 193.

In step S1401, the control unit 203 waits for input of birth information, etc. by the user of the terminal device 10, and if the user's operation input is accepted (YES in step S1401), it proceeds to step S1402. Specifically, for example, the operation reception unit 191 of the control unit 190 of the terminal device 10 accepts the operation input of birth information, etc. input by the user via the touch sensitive device 131 and transmits the input birth information, etc. to server via the 20 the transmission/reception unit 192, communication unit 120 and network 80. The control unit 203 of the server 20, for example, accepts the birth information, etc. of the user transmitted from the terminal device 10 by the birth information, etc. acquisition module 2033 and stores it in the user information DB 2021.

In step S1402, the control unit 203 generates keywords based on the birth information, etc. of the user of the terminal device 10 accepted in step S1401 and, if necessary, the predetermined date and time (generally, the current date and time), which is second information. Specifically, for example, the control unit 203 generates keywords by the keyword generation module 2034 based on the birth information, etc. of the user of the terminal device 10 and, if necessary, the predetermined date and time, which is the second information.

In step S1403, control unit 203 selects fewer keywords than those generated in step S1402. Specifically, for example, the control unit 203 selects keywords by the keyword selection module 2035. In this case, as already explained, the keyword selection module 2035 assigns attributes and weighting values to the keywords generated by the keyword generation module 2034, stores the assigned attributes, etc. in the keyword information DB 2022, and performs keyword selection based on these attributes, etc. The keyword selection process is performed based on these attributes, etc.

In step S1404, control unit 203 of server 20 and/or control unit 303 of e-commerce server 30 searches within e-commerce server (site) 30. Specifically, the control unit 203 and 303 search within the e-commerce server 30 with the site search module 2036 and/or the intra-site search module 3033. It is arbitrarily selectable which of the site search module 2036 and the within-site search module 3033 searches the e-commerce server 30.

In step S1405, control unit 203 of server 20 and/or control unit 303 of e-commerce server 30 extracts site keywords based on the search results in step S1404. Specifically, the control unit 203 and 303 extract the site keywords based on the results of the search within the e-commerce server 30 by the site search module 2036 and/or the site search module 3033.

In step S1406, control unit 203 performs matching between the keywords selected in step S1403 and the site keywords extracted in step S1405. Specifically, for example, the control unit 203 matches the keywords with the site keywords by the service selection module 2037.

Then, in step S1407, the control unit 203 selects a service to be presented to the user of the terminal device 10 based on the matching result in step S1406, and sends information about the selected service to the terminal device 10. Specifically, for example, the control unit 203 uses the service selection module 2037 and the service presentation module 2038 to select a service to present to the user of the terminal device 10, and sends information about the selected service to the terminal device 10. At this time, the service presentation module 2038 also refers to the information presented by the information presentation module 3034 of the e-commerce server 30 and sends information about the selected service to the terminal device 10.

### 4 Screen Example

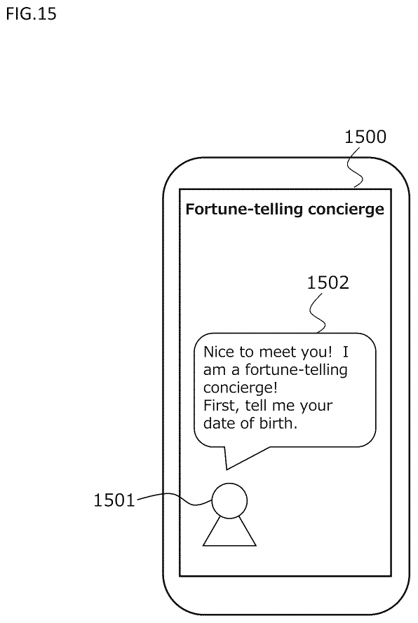

The following is an example of a screen output to terminal device 10, with reference to FIGS. 15 through 20. FIG. 15 shows the screen displayed on the terminal device 10 when a user of the terminal device 10 logs into the system 1 (server 20).

The screen 1500 of the terminal device 10 displays an avatar 1501 generated by the avatar management module 2039 of the server 20 and an area 1502 in which questions from this avatar 1501 are displayed. The area 1502 includes a request for the user to enter birth information and other information about the user of the terminal device 10.

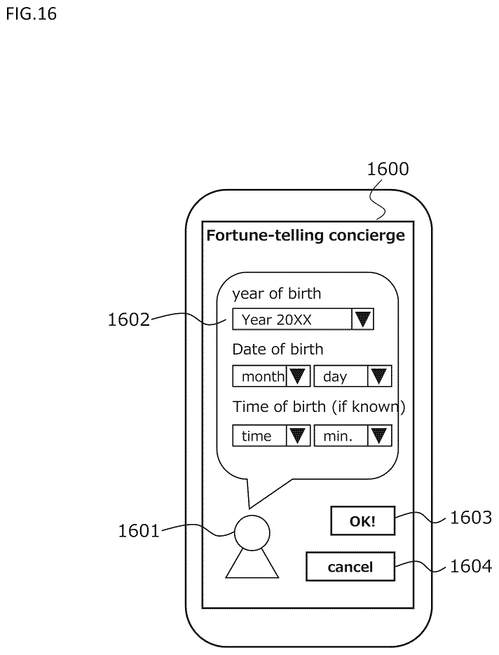

FIG. 16 shows the screen displayed on terminal device 10 following the display of the screen shown in FIG. 15.

The avatar management module 2039 and the birth information and other information acquisition module 2033 of server 20 cause terminal device 10 to display screen 1600 on its display 141, as shown in FIG. 16. Screen 1600 continues to display avatar 1601, and area 1602 in which questions from this avatar 1601 are displayed. In area 1602, there is a field for inputting the user's birth information and other information. The user of terminal device 10 enters birth information, etc. in area 1602, and if the user decides that the entered birth information, etc. can be sent to server 20, the user performs the entry operation by touching the “OK!” button 1603. On the other hand, if the user does not wish to transmit the birth information, the user touches the “Cancel” button 1604. When the user touches the “OK!” button 1603, the birth information, etc. of the user of terminal device 10 is sent to server 20 and stored in the user information DB 2021.

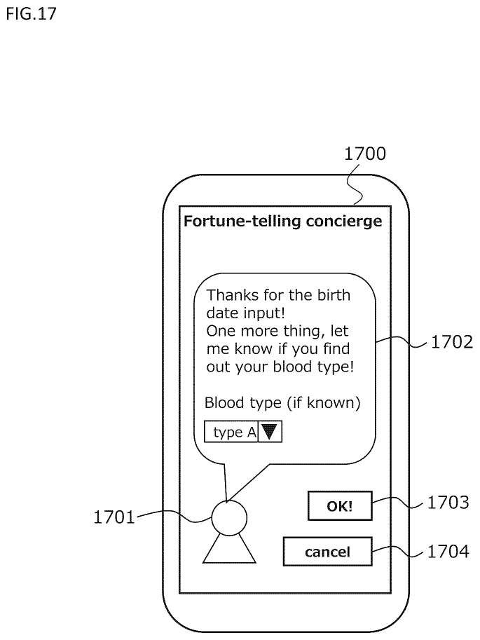

FIG. 17 shows the screen displayed on the terminal device 10 to ask the user of the terminal device 10 to enter blood type information in response to the user of the terminal device 10's input operation of the “OK!” button 1603 in FIG. 16.

The avatar management module 2039 and the birth information and other information acquisition module 2033 of server 20 cause terminal device 10 to display screen 1700 on its display 141, as shown in FIG. 17. The screen 1700 continues to display the avatar 1701 and an area 1702 in which questions from this avatar 1701 are displayed. The area 1702 has a field for entering the user's blood type. The user of the terminal device 10 enters the blood type in the area 1702, and if the user decides that the entered blood type information is acceptable for transmission to the server 20, the user performs the input operation by touching the “OK!” button 1703. On the other hand, if the user does not wish to send the blood type information, the user touches the “Cancel” button 1704 or performs other input operations. When the user touches the “OK!” button 1703, the blood type information of the user of terminal device 10 is sent to server 20 and stored in the user information DB 2021.

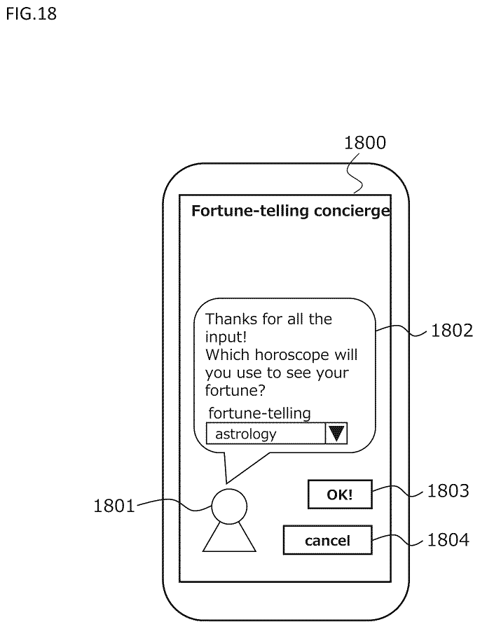

FIG. 18 shows a screen that allows the user to select which fortune-telling engine is used to generate keywords when the keyword generation module 2034 generates keywords based on birth information, etc. entered by the user of terminal device 10.

The avatar management module 2039 and keyword generation module 2034 of server 20 causes terminal device 10 to display screen 1700 on its display 141, as shown in FIG. 18. Screen 1800 continues to display avatar 1801, and area 1802 in which questions from this avatar 1801 are displayed. In area 1802, there is a column that allows the user of terminal device 10 to select a fortune-telling engine. The user of terminal device 10 selects and inputs the fortune-telling engine in area 1802, and if the user decides that the information about the fortune-telling selected and inputted is acceptable for transmission to server 20, the user performs the input operation by touching the “OK!” button 1803. On the other hand, if the user does not wish to send information about the fortune-telling engine, the user touches the “Cancel” button 1804, and so on. When the user touches the “OK!” button 1803, information about the fortune-telling engine selected by the user of terminal device 10 is sent to server 20, and the keyword generation module 2034 generates keywords using the fortune-telling engine selected by the user.

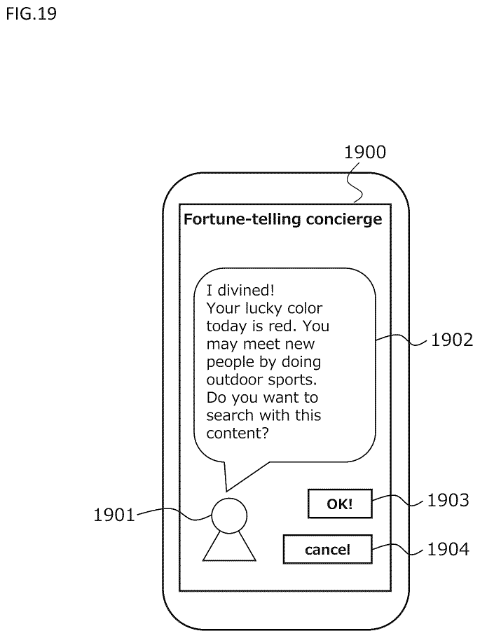

FIG. 19 shows the screen where the keyword generation module 2034 generates keywords based on birth information and other information entered by the user of terminal device 10, and the keyword selection module 2035 displays the results of the selection based on the generated keywords.

The avatar management module 2039 and keyword selection module 2035 of server 20 causes terminal device 10 to display screen 1900 on its display 141, as shown in FIG. 19. Screen 1900 continues to display avatar 1901, and area 1902 in which questions from this avatar 1901 are displayed. The area 1902 displays the keywords selected by the keyword selection module 2035 (which are also the result of the fortune-telling by the fortune-telling engine), and the question whether or not to search within the e-commerce server 30 using these keywords. If the user of terminal device 10 decides that he/she may search e-commerce server 30 by server 20 based on the fortune-telling result displayed in area 1902, the user performs an input operation such as touching the “OK!” button 1903. On the other hand, if the user does not wish to search the e-commerce server 30 based on the fortune-telling result, the user touches the “Cancel” button 1904 or performs some other input operation. When the “OK!” button 1903 is touched, the site search module 2036 and/or the site search module 3033 searches the e-commerce server 30 to obtain site keywords, and the keyword selection module 2035 performs the matching process between the selected keywords and the site keywords. The service selection module 2037 performs the matching process with the keywords.

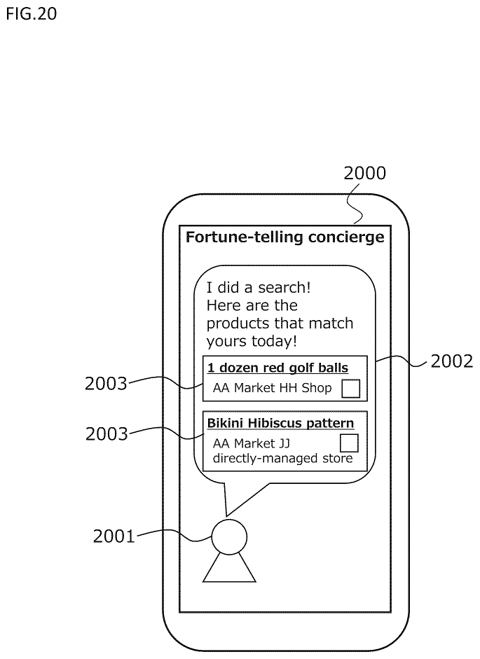

FIG. 20 shows a screen displaying the services presented by the service presentation module 2038.

The avatar management module 2039 and service presentation module 2038 of server 20 causes terminal device 10 to display on its display 141 a screen 2000 as shown in FIG. 20. The screen 2000 continues to display the avatar 2001, and an area 2002 in which messages from this avatar 2001 are displayed. The area 2002 displays information 2003 indicating services in the e-commerce server 30, which is the content of the presentation from the service presentation module 2038.

### 5 Effect of the First Embodiment

As explained in detail above, according to the system 1 of the present embodiment, the system accepts input from the user of terminal device 10 such as birth information, which is unique information of the user, generates keywords related to the user based on this birth information, etc., while searching e-commerce server 30 to obtain site keywords, and presents services on e-commerce server 30 to the user of terminal device 10. By matching the keywords and site keywords, the service on the e-commerce server 30 is presented to the user of the terminal device 10. This provides a technology that makes it possible to receive recommendations to an individual without identifying personal information.

The keywords generated by the keyword generation module 2034 of server 20 are based on information that discards most of the user's personal information, even though they are based on the user's birth information and other information. In other words, the user can obtain keywords related to the user without providing the system 1 with his/her name and address, which are information that identifies the individual, and can receive presentations of services in the e-commerce server 30 based on these keywords. Thus, the user of terminal device 10 can receive presentations of services that match the user's preferences without providing personal information such as name and address to server 20 and e-commerce server 30.

The avatar generated in the system 1 according to the present embodiment can act as the alter ego of the user of terminal device 10, so to speak. The avatar then crawls the e-commerce server 30 and presents recommended services, both apparently and virtually. Moreover, in the present embodiment of system 1, the user of terminal device 10 does not need to actively crawl the e-commerce server 30, and once birth information, etc. is provided to system 1, system 1 (server 20) can crawl the e-commerce server 30 24 hours a day, if possible, using this birth information, etc. as a key. This saves time and effort for the user of terminal device 10.

### Second Embodiment

### 6.1 Functional Configuration of the Server 20

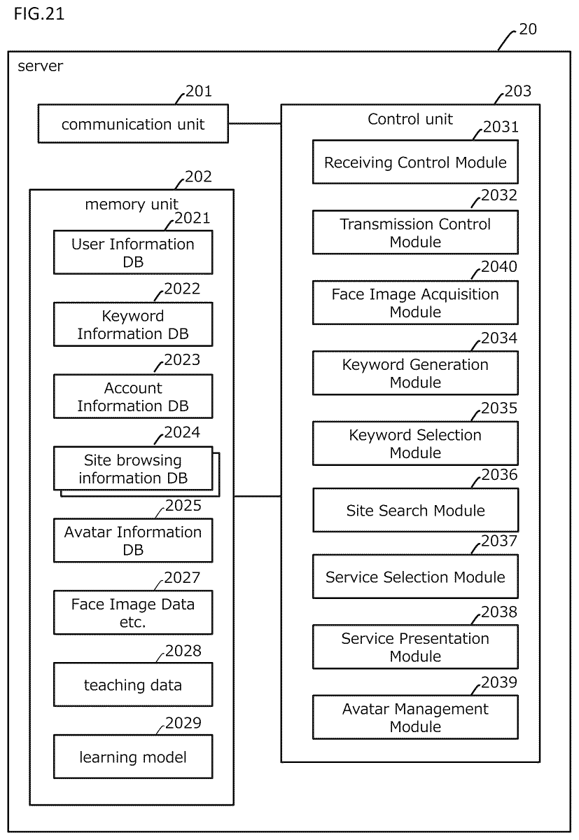

FIG. 21 shows an example of the functional configuration of the server 20 in the second embodiment. In the description of the second embodiment, explanations are omitted for the parts that have the same configuration as the first embodiment.

The storage unit 202 of server 20 in this embodiment has face image and other data 2027, teacher data 2028, and a learning model 2029, in addition to the database stored in storage unit 202 for the first embodiment (excluding keyword DB 2026).

The face image and other data 2027 is face image data and/or palm image data obtained by the face image and other acquisition module 2040 from the user of the terminal device 10. The teaching data 2028 is data about the correspondence between the characteristic parts of the user's face obtained from the face image and their arrangement, and/or the palm lines obtained from the palm image and their arrangement, and the keywords to be generated by the keyword generation module 2034 based on this information. The learning model 2029 is a machine learning (deep learning) model 2029 based on the teaching data 2028, with the feature portions of the user's face and their arrangement and/or the palm lines and their arrangement as explanatory variables and the keywords as objective variables.

The control unit 203 of the server 20 in the present embodiment has a face image etc. acquisition module 2040 instead of the birth information etc. acquisition module 2033 of the first embodiment. The face image etc. acquisition module 2040 accepts input from the user of the terminal device 10 of the face image and palm image, which are unique information of this user. The face image acquisition module 2040 stores the accepted face image and palm image in the face image data 2026 of the storage unit 202.

The keyword generation module 2034 then generates keywords based on the accepted face and palm images.

First, the keyword generation module 2034 detects the characteristic parts of the user's face and its arrangement from the accepted face and palm images, and/or the palm lines and their arrangement from the palm images. These facial feature portions and their arrangements and palm lines and their arrangements are input values for outputting fortune-telling results in so-called face and palm reading. The characteristic parts of a face and their arrangement, palm lines and their arrangement can be obtained based on known methods such as edge detection or feature extraction for face and palm images. Therefore, a description of specific methods is omitted here.

The keyword generation module 2034 then inputs the feature parts of the user's face and their arrangement, and/or the palm lines and their arrangement obtained from the palm image, to the learning model 2029 to obtain the keywords output from the learning model 2029, which 34 generates the keywords.

The teaching data 2028 embodies the already established results of facial and palmistry fortune-telling as teaching data 2028. It can be said that facial physiognomy and palm reading are also processes based on statistical data accumulated over many years, and therefore, the 2028 teacher data can be created based on the findings of facial physiognomy and palm reading. The learning model 2029 is then learned using this teaching data 2028, and is therefore a facial physiognomy engine or palm reading engine.

Naturally, the keyword generation module 2034 may generate keywords based on the user's facial feature parts and their placement and/or palm lines and their placement without using the teaching data 2028 and training model 2029.

### 7 Example of Operation

The following is an example of the operation of server 20.

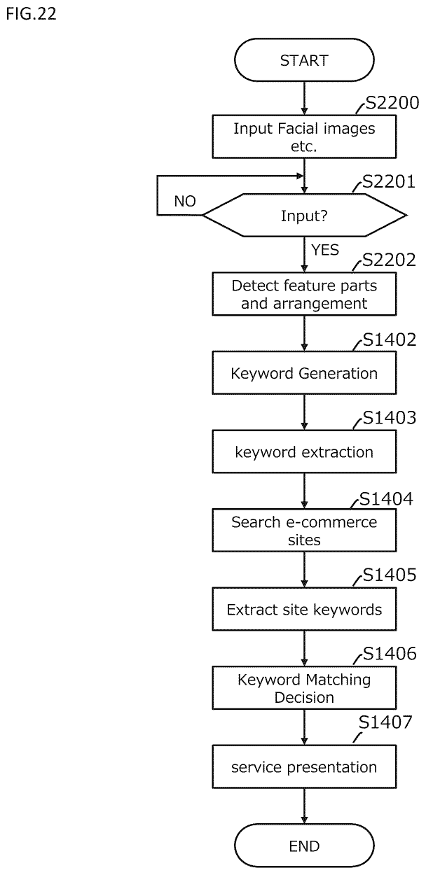

FIG. 22 is a flowchart representing an example of the operation of the server 20 according to the second embodiment.

First, in step S2200, the control unit 203 requests the user of the terminal device 10 to input a face image and/or palm image. Specifically, for example, the control unit 203 generates screen data with the face image, etc. acquisition module 2040 and sends the generated screen data to the terminal device 10 via the network 80. The control unit 190 of the terminal device 10 to which the screen data is sent receives the screen data via, for example, the transmission/reception unit 192 and the communication unit 120, and generates and displays a predetermined display screen on the display 141 based on the received screen data by the presentation control unit 193.

In step S2201, the control unit 203 waits for input of the face image, etc. by the user of the terminal device 10, and if the user's operation input is accepted (YES in step S2201), it proceeds to step S2202. Specifically, for example, the operation reception unit 191 of the control unit 190 of the terminal device 10 accepts the selection input of the face image, etc. data 183 input by the user via the touch sensitive device 131, and transmits the selected input face image, etc. data 183, etc. to the transmission/reception unit 192, the communication unit 120 and the network 80 The control unit 203 of the server 20 accepts the user's face image etc. data transmitted from the terminal device 10, for example, by the face image etc. acquisition module 2040, and stores it in the face image etc. data 2027.

In step S2202, the control unit 203 detects the characteristic portions of the user's face and their arrangement and/or the palm lines and their arrangement obtained from the palm image based on the face image and other data 2027 obtained in step S2201. Specifically, for example, the control unit 203 detects, by the keyword generation module 2034, the characteristic portions of the user's face and their arrangement and/or the palm lines and their arrangement obtained from the palm image based on the face image etc. data 2027.

The operation of server 20 thereafter is the same as the operation of server 20 in the first embodiment, so the description is omitted by appending the step numbers in the first embodiment.

### 8 Screen Example

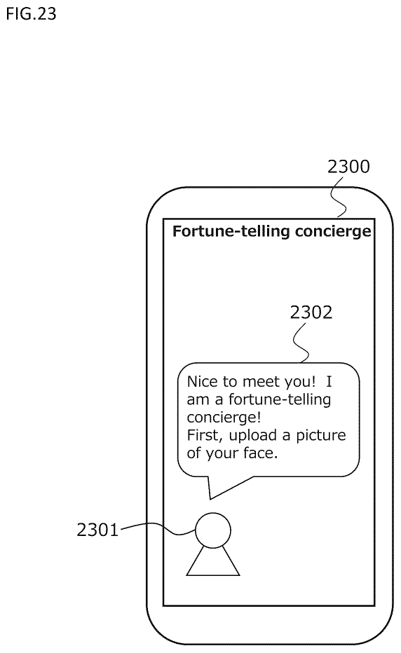

FIG. 23 shows the screen displayed on the terminal device 10 when a user of the terminal device 10 logs into the system 1 (server 20).

The screen 2300 of the terminal device 10 displays an avatar 2301 generated by the avatar management module 2039 of the server 20 and an area 2302 in which questions from this avatar 2301 are displayed. In area 2302, it is indicated that the user is asked to input a face image or other information of the user of terminal device 10.

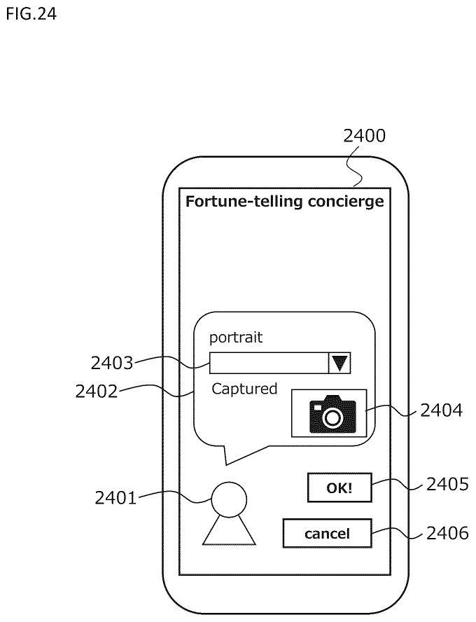

FIG. 24 shows the screen displayed on terminal device 10 following the display of the screen shown in FIG. 23.

The avatar management module 2039 and the face image acquisition module 2040 of server 20 cause terminal device 10 to display screen 2400 on its display 141, as shown in FIG. 24. The screen 2400 continues to display avatar 2401, and area 2402 in which questions from avatar 2401 are displayed. The area 2402 has a column 2403 for selecting the face image and other data 183 stored in the memory 180 of the terminal device 10, and an icon 2404 for having a new image of the user's face and palm taken by the camera 160 of the terminal device 10. The user of terminal device 10 selects the face image data 183 using column 2403, or inputs an instruction to capture the face or palm using camera 160 by touching icon 2404, etc., to acquire the face image data 183. If the user of terminal device 10 decides that the input face image or other data can be sent to server 20, the user performs the input operation by touching the “OK!” button 2405 or the like. On the other hand, if the user does not wish to send the face image data, the user touches the “Cancel” button 2406 or performs some other input operation. When the “OK!” button 2405 is touched or other input operations are performed, the face image or other data 183 of the user of terminal device 10 is sent to server 20 and stored in face image or other data 2027.

### 9 Effect of the Second Embodiment

Therefore, the same effects as those of the system 1 of the first embodiment can be obtained by the system 1 of the second embodiment.

### 10 APPENDIX

Note that, in the above-described embodiment, the configurations have been described in detail for describing the present disclosure in an easy-to-understand manner, and the present disclosure is not necessarily limited to the embodiment including all the described configurations. Additionally, it is possible to add, delete, and replace a part of the configuration of each embodiment with another configuration.

Additionally, a part or all of each of the above-described configurations, functions, processing units, processing means, and the like may be realized in hardware by designing them with, for example, integrated circuits. Additionally, the present invention can also be realized in a program code of software that realizes the functions of the present embodiment. In this case, a storage medium recording the program code is provided to a computer, and a processor included in the computer reads the program code stored in the storage medium. In this case, the program code itself read from the storage medium will realize the functions of the present embodiment, and the program code itself and the storage medium storing the program code will constitute the present invention. As a storage medium for supplying such a program code, for example, a flexible disk, a CD-ROM, a DVD-ROM, a hard disk, an SSD, an optical disc, a magneto-optical disc, a CD-R, a magnetic tape, a nonvolatile memory card, a ROM, or the like is used.

Additionally, the program code that realizes the functions described in the present embodiment can be implemented in a wide range of programing languages or script languages, such as an assembler, C/C++, Perl, Shell, PHP, and Java (registered trademark).

Further, the program code of the software that realizes the functions of the present embodiment may be distributed via a network, it may be stored in storing means such as a hard disk and a memory of a computer, or in a storage medium such as a CD-RW and a CD-R, and a processor included in a computer may read and execute the program code stored in the storing means or the storage medium.

The matters described in each of the above forms are appended below.

### (Appendix 1)

A program for operating a computer (20) provided with a processor (29) and a memory (25), the program comprising the steps of causing the processor (29) to accept input (S1401) from a user of first information concerning birth information of the user, to generate keywords related to the user based on the first information accepted (S1401), generating keywords related to the user based on the first information accepted in step (S1402) and the second information related to the predetermined date and time, searching the service site (30) using the keywords and presenting services at the service site (30) to the user based on this search result The program causes the user to perform the step (S1407).

### (Appendix 2)

A program for operating a computer (20) provided with a processor (29) and a memory (25), the program comprising the step (S2201) of having the processor (29) accept input from a user of at least one of a face image or a palm image of the user, detecting from the face image a feature portion of the face of the user and its arrangement and/or detecting from the palm image a palm line of the user and its arrangement detecting a feature portion of the user's face and its arrangement from the face image and/or detecting a palm line of the user and its arrangement from the palm image (S2202), generating keywords about the user based on the feature portion of the user's face and its arrangement, and/or the palm line of the user and its arrangement (S1402), and searching the service site (30) using the keywords The program causes the user to execute a step (S1407) of searching a service site (30) using the keywords and presenting services at the service site (30) to the user based on the results of this search.

### (Appendix 3)

The keywords are keywords that are uniquely determined based on the first and second information.

### (Appendix 4)

The birth information necessarily includes information about the user's date of birth and can include information about the user's birth time, location information of the user's birth place, and the user's blood type.

### (Appendix 5)

In the step of generating keywords (S1402), a plurality of keywords are generated, the program as described in any of Appendices 1 to 4.

### (Appendix 6)

In the step of generating keywords (S1402), the program described in Appendix 5 is weighted for each keyword.

### (Appendix 7)

In the step (S1407) of presenting the services at the service site (30) to the user, keywords for searching against the service site (30) are selected based on weighting, the program as described in Appendix 6.

### (Appendix 8)

In the step (S1407) of presenting the services at the service site (30) to the user, the program as described in Appendix 6 selects keywords for a search against the service site (30) based on the attributes of the keywords.

### (Appendix 9)

The service site (30) is an e-commerce site (30), the program described in any of Appendices 1-8.

### (Appendix 10)

In the step (S1407) of presenting a service at the service site (30) to the user, the program as described in Appendix 9 presents the service to the user based on the user's purchase history (3021) at the e-commerce site (30).

### (Appendix 11)

In the step (S1407) of presenting services at the service site (30) to the user, information about products or services sold at the e-commerce site (30) is presented to the user based on the user's past purchase history (3021) and search results using keywords, The program as described in Appendix 10.

### (Appendix 12)

In the step (S1407) of presenting a service at the service site (30) to a user, based on the purchase history (3021) at the e-commerce site (30) of a user, including a user using the e-commerce site (30), the product sold at the e-commerce site (30) or services sold at the e-commerce site (30) based on the purchase history (3021) at the e-commerce site (30) of a user, including the user, at the e-commerce site (30).

### (Appendix 13)

In the step (S1407) of presenting services on the service site (30) to the user, the program of the addendum 11 presents information to the user about goods or services sold on the e-commerce site (30) based on the purchase history (3021) and keyword search results on the e-commerce site (30) of users who have common first information, or common facial feature parts and their arrangement, and/or common palm lines and their arrangement program as described in the attached document 11, which presents information to a user about goods or services sold on an e-commerce site (30) based on the user's purchase history (3021) on the e-commerce site (30) and search results using keywords.

### (Appendix 14)

A program as described in Appendix 9 that presents a service to a user in a service site (S1407) without being based on the purchase history (3021) of the user in an e-commerce site (30).

### (Appendix 15)

A program as described in Appendix 5, in which, in the step of generating keywords (S1402), parameters used when searching the e-commerce site (30) are associated with each keyword.

### (Appendix 16)

A program as described in Additional 15, which, in the step of presenting a service on the service site (30) to a user (S1407), increases the value of a parameter if the user purchases the product or service as a result of being presented with information about the product or service, and decreases the value of the parameter if the user does not purchase the product or service.

### (Appendix 17)

A program as described in Appendix 16, which, in a step (S1407) of presenting a service on a service site (30) to a user, detects the time spent on an e-commerce site (30) on which the presented product or service is displayed, and increases or decreases the value of a parameter based on this time spent.

### (Appendix 18)

The program further has a step of generating an avatar (1501) that symbolizes the user in the virtual space based on the keyword generated in the step of generating a keyword about the user (S1402), the program described in any of the Appendices 1 to 17.

### (Appendix 19)

A program as described in Appendix 18, wherein, in the step of generating an avatar in a virtual space, at least one of the behavior pattern and personality of the avatar (1501) is set based on the keyword.

### (Appendix 20)

A learning model (2029) is stored in the memory (25), in which the feature parts of the user's face and their arrangement, and/or the palm lines of the user and their arrangement are explanatory variables, and the keywords are objective variables. in the step of generating keywords (S1402), the program described in Appendix 2 generates keywords by inputting the feature parts of the user's face and their arrangement, and/or the palm lines of the user and their arrangement into the learning model (2029).

### (Appendix 21)

A program for operating a computer (20) having a processor (29) and memory (25), the program comprising: a step (S1401) of accepting input of first information from a user about the user's birth information by the processor (29); a step (S1402) of generating keywords related to the user based on the first information accepted in the step (S1401) and a step of generating keywords related to the user based on the first information and second information related to a predetermined date and time (S1402), and a step of presenting the keywords to a service site (30) and receiving search results from the service site (30), and presenting services at the service site (30) to the user based on the search results (S1407).

### (Appendix 22)

A program for operating a computer (20) having a processor (29) and memory (25), the program causing the processor (29) to accept input of at least one of a user's facial image or a user's palm image from a user (S2201), detect a feature part of the user's face and its arrangement from the facial image and/or detect a palm line of the user and its arrangement from the palm image (S2202) and a program that executes the steps of generating keywords related to the user based on the characteristic parts of the user's face and their arrangement, and/or the palm lines of the user and their arrangement (S1402), and presenting the keywords to the service site (30) and receiving search results from the service site (30), and presenting services on the service site (30) to the user based on the search results (S1407).

### (Appendix 23)

An information processing device (20) comprising a processor (29) and memory (25), wherein the processor (29) accepts input of first information from a user regarding the user's birth information (S1401), and, and a step of generating keywords related to the user based on the first information and second information related to a predetermined date and time (S1402), and a step of searching a service site (30) using the keywords and presenting services on the service site (30) to the user based on the search results (S1407).

### (Appendix 24)

An information processing device (20) comprising a processor (29) and a memory (25), wherein the processor (29) accepts input from a user of at least one of a facial image or a palm image of the user (S2201), detects feature parts of the user's face and their arrangement from the facial image and/or detects lines of the user's palm and their arrangement from the palm image (S2202), and a step of generating keywords related to the user based on the characteristic parts of the user's face and their arrangement, and/or the palm lines of the user and their arrangement (S1402), and a step of searching for a service site (30) using the keywords, and presenting services on the service site (30) to the user based on the search results (S1407).

### (Appendix 25)

An information processing device (20) comprising a processor (29) and a memory (25), wherein the processor (29) accepts input of first information from a user regarding the user's birth information (S1401), and generates keywords related to the user based on the first information accepted in the input acceptance step (S1401) and second information and based on the first information and the second information, generate keywords related to the user (S1402), and present the keywords to the service site (30) and receive search results from the service site (30), and present services at the service site (30) to the user based on the search results (S1407).

### (Appendix 26)

An information processing device (20) comprising a processor (29) and a memory (25), wherein the processor (29) accepts input from a user of at least one of a face image or a palm image of the user (S2201), detects feature parts of the user's face and their arrangement from the face image and/or detects lines of the user's palm and their arrangement from the palm image (S2202) and a step of generating keywords related to the user based on the characteristic parts of the user's face and their arrangement, and/or the lines of the user's palm and their arrangement (S1402), and a step of presenting the keywords to a service site (30) and receiving search results from the service site (30), and presenting services at the service site (30) to the user based on the search results (S1407).

### (Appendix 27)

A method executed by a computer (20) equipped with a processor (29) and memory (25), wherein the processor (29) accepts input of first information from a user regarding the user's birth information at a step (S1401) and first information and second information related to a predetermined date and time, and then searching for a service site (30) using the keyword, and presenting a service on the service site (30) to the user based on the search results (S1407).

### (Appendix 28)

A method executed by a computer (20) equipped with a processor (29) and memory (25), wherein the processor (29) accepts input of at least one of a user's facial image or a user's palm image from a user (S2201), detects a feature part of the user's face and its arrangement from the facial image and/or detects a palm line of the user and its arrangement from the palm image detect the feature parts of the user's face and their arrangement, and/or the palm lines of the user and their arrangement, and generate keywords about the user based on the feature parts of the user's face and their arrangement, and/or the palm lines of the user and their arrangement, and search the service site (30) using the keywords, and present services on the service site (30) to the user based on the search results (S1407).

### (Appendix 29)

A method executed by a computer (20) equipped with a processor (29) and memory (25), wherein the processor (29) accepts input of first information from a user regarding the user's birth information (S1401), and generates keywords related to the user based on the first information accepted in the step (S1401) and second information regarding a predetermined date time-related second information, and generating a keyword related to the user based on the first information and the second information (S1402); and presenting the keyword to a service site (30), receiving search results from the service site (30), and presenting services at the service site (30) to the user based on the search results (S1407).

### (Appendix 30)

A method executed by a computer (20) equipped with a processor (29) and memory (25), wherein the processor (29) accepts input of at least one of a user's facial image or a palm image from a user (S2201), detects a feature part of the user's face and its arrangement from the facial image and/or detects a palm line of the user and its arrangement from the palm image (S2202), a step of generating keywords related to the user based on the characteristic parts of the user's face and their arrangement, and/or the lines on the user's palm and their arrangement (S1402), a step of presenting the keywords to the service site (30) and receiving search results from the service site (30), and a step of presenting services on the service site (30) to the user based on the search results (S1407).

### (Appendix 31)

A method comprising: a means (2033) for receiving input of first information from a user regarding the user's birth information; a means (2034) for generating keywords (2034) and a means (2038) for searching a service site (30) using the keywords and presenting services on the service site (30) to the user based on the search results.

### (Appendix 32)

A system (1) comprising: a means (2040) for receiving input from a user of at least one of a facial image and a palm image of the user; a means (2034) for detecting facial features and their arrangement of the user from the facial image and/or detecting palm lines and their arrangement of the user from the palm image; and and/or the user's palm lines and their arrangement, and a means (2034) for generating keywords related to the user based on the user's facial features and their arrangement and/or the user's palm lines and their arrangement, and a means (2038) for searching a service site (30) using the keywords and presenting services on the service site (30) to the user based on the search results.

(Appendix 33) A system (1) comprising: a means (2033) for receiving input of first information from a user regarding the user's birth information; a means (2034) for generating keywords related to the user based on the first information received by the means (2033) and second information regarding a predetermined date and time; and 034) and a means (2038) for presenting the keywords to a service site (30) and receiving search results from this service site (30), and presenting services on the service site (30) to the user based on these search results.

### (Appendix 34)

A system (1) comprising: a means (2040) for receiving input from a user of at least one of a facial image and a palm image of the user; a means (2034) for detecting facial features and their arrangement of the user from the facial image and/or detecting palm lines and their arrangement of the user from the palm image; a means (2034) for generating keywords related to the user based on the facial features and their arrangement of the user and/or the palm lines and their arrangement of the user palm lines and their arrangement, and a means (2038) for presenting the keywords to a service site (30) and receiving search results from this service site (30), and presenting services on the service site (30) to the user based on these search results.

What is claimed is:

1. An apparatus comprising:
processing circuitry configured to:
accept first information input from the user regarding the user's birth information;
generate keywords related to the user based on the first information accepted in accepting the input and the second information about the given date and time; and
search for a service site using the keywords and presenting services at the service site to the user based on the search results.

2. An apparatus comprising:
processing circuitry configured to:
accept input from the user of at least one of said user's face image or palm image;
detect the user's facial feature areas and their placement from the face image and/or detecting the user's palm lines and their placement from the palm image;
generate keywords about the user based on said feature portions of said user's face and their arrangement and/or said palm lines of said user and their arrangement; and
search for a service site using the keywords and presenting the services at the service site to the user based on the search results.

3. The apparatus according to claim 1,
wherein said keywords are uniquely determined based on said first and second information.

4. The apparatus according to claim 1,
wherein the birth information necessarily includes information about the user's date of birth and may include information about the user's birth time, location information of the user's birth location, and the user's blood type.

5. The apparatus according to claim 1,
wherein in generating said keywords, a plurality of said keywords are generated.

6. The apparatus according to claim 5,
wherein in generating the keywords, a weight is assigned to each of said keywords.

7. The apparatus according to claim 6,
wherein in presenting said services at said service site to said user, said keywords to search for said service site are selected based on said weighting.

8. The apparatus according to claim 6,
wherein in presenting said services at said service site to said user, said keywords to search for said service site are selected based on the attributes of said keywords.

9. The apparatus according to claim 1,
wherein the service site is an e-commerce site.

10. The apparatus according to claim 9,
wherein in presenting said service at said service site to said user, said service is presented to said user based on said user's purchase history at said e-commerce site.

11. The apparatus according to claim 10,
wherein in presenting said service at said service site to said user, information about products or services sold at said e-commerce site is presented to said user based on said user's past purchase history and said search results using said keywords.

12. The apparatus according to claim 11,
wherein in presenting said service at said service site to said user, based on said purchase history at said e-commerce site of users, including said user using said e-commerce site, information regarding said goods or services sold at said e-commerce site is presented.

13. The apparatus according to claim 1,
wherein in presenting said services at said service site to said user,
presenting information to the user about products or services sold on the e-commerce site based on the user's past purchase history and the search results by the keywords, and moreover,
presenting information regarding goods or services sold at said e-commerce site to said user based on said purchase history at said e-commerce site of a user with whom said first information regarding said birth information of said user is common and said search results using said keywords.

14. The apparatus according to claim 2,
wherein in the step of presenting said services at said service site to said user,
presenting information to the user about products or services sold on the e-commerce site based on the user's past purchase history and the search results by the keywords, and moreover,
resenting information regarding goods or services sold at said e-commerce site to said user based on said purchase history at said e-commerce site of users who share said characteristic parts of said face and their arrangement and/or said palm lines and their arrangement, and said search results by said keywords.

15. The apparatus according to claim 9,
wherein in presenting said service at said service site to said user, said service is presented to said user without being based on said user's purchase history at said e-commerce site.

16. The apparatus according to claim 11,
wherein in generating said keywords, a plurality of said keywords are generated and for each of said keywords, a parameter to be used in searching said service site is associated.

17. The apparatus according to claim 16,
wherein in presenting said service at said service site to said user, if said user purchases said product or service as a result of presenting information about said product or service to said user, the value of said parameter is increased, and if said user does not purchase said goods or services as a result of said presentation of information regarding said goods or services to said user, said parameter value is decreased.

18. The apparatus according to claim 17,
wherein in presenting said service at said service site to said user, the time spent at said service site where said product or said service presented to said user is displayed is detected, and the value of said parameter is increased or decreased based on this time spent.

19. The apparatus according to claim 1,
the processing circuitry further configured to:
generate an avatar symbolizing said user in the virtual space based on said keywords generated in the step of generating said keywords concerning said user.

20. The apparatus according to claim 19,
wherein in generating the avatar in the virtual space, at least one of the behavior pattern and personality of the avatar is set based on the keywords.

21. The apparatus according to claim 2,
the processing circuitry further configured to:
store a learning model in which said feature parts of the user's face and their arrangement and/or said palm lines of the user and their arrangement are explanatory variables and said keywords are objective variables in a memory; and
wherein in generating said keywords regarding said user, said keywords are generated by inputting said feature portions of said user's face and their arrangement and/or said palm lines of said user and their arrangement into said learning model.

22. A method to be executed by a computer,
wherein the computer comprises a processor and a memory, and
the processor executes:
a step of accepting first information input from the user regarding the user's birth information;
a step of generating keywords related to the user based on the first information accepted in the step of accepting the input and the second information about the given date and time; and
a step of searching for a service site using the keywords and presenting services at the service site to the user based on the search results.

23. A method to be executed by a computer,
wherein the computer comprises a processor and a memory, and
the processor executes:
a step of accepting input from the user of at least one of said user's face image or palm image;
a step of detecting the user's facial feature areas and their placement from the face image and/or detecting the user's palm lines and their placement from the palm image;
a step of generating keywords about the user based on said feature portions of said user's face and their arrangement, and/or said palm lines of said user and their arrangement; and
a step of searching for a service site using the keywords and presenting services at the service site to the user based on the search results.

24. A method to be executed by a computer,
wherein the computer comprises a processor and a memory, and
the processor executes:
a step of accepting first information input from the user regarding the user's birth information;
a step of generating keywords related to the user based on the first information accepted in the step of accepting the input and the second information about the given date and time; and
a step of presenting the keywords to a service site, receiving search results from the service site, and presenting services at the service site to the user based on the search results.

25. A method to be executed by a computer,
wherein the computer comprises a processor and a memory, and
the processor executes:
a step of accepting input from the user of at least one of said user's face image or palm image;
a step of detecting the user's facial feature areas and their placement from the face image and/or detecting the user's palm lines and their placement from the palm image, The step of generating keywords about the user based on said feature portions of said user's face and their arrangement, and/or said palm lines of said user and their arrangement; and
a step of presenting the keywords to a service site, receiving search results from the service site, and presenting services at the service site to the user based on the search results.

26. A system comprising:
means for accepting input of first information from the user regarding said user's birth information;
means for generating keywords related to the user based on the first information accepted by the means for accepting input of the first information and the second information related to the given date and time; and
means for searching for a service site using said keywords and presenting services at said service site to said user based on the search results.

27. A system comprising:
means for accepting input from the user of at least one of said user's face image or palm image;
means for detecting the characteristic parts of the user's face and their arrangement from said face image and/or detecting the user's palm lines and their arrangement from said palm image;
means for generating keywords about said user based on said feature portions of said user's face and their arrangement, and/or said palm lines of said user and their arrangement; and
means for searching for a service site using said keywords and presenting services at said service site to said user based on the search results.

28. A system comprising:
means for accepting input of first information from the user regarding said user's birth information;
means for generating keywords related to the user based on the first information accepted by the means for accepting input of the first information and the second information related to the given date and time; and
means for presenting said keywords to a service site, receiving search results from this service site, and presenting services at said service site to the user based on these search results.

29. A system comprising:
means for accepting input from the user of at least one of said user's face image or palm image;
means for detecting the characteristic parts of the user's face and their arrangement from said face image and/or detecting the user's palm lines and their arrangement from said palm image;
means for generating keywords about said user based on said feature portions of said user's face and their arrangement, and/or said palm lines of said user and their arrangement; and
means for presenting said keywords to a service site, receiving search results from this service site, and presenting services at said service site to the user based on these search results.
